(19) United States
(12) Patent Application Publication
(10) Pub. No.: US 2022/0132937 A1
(43) Pub. Date: May 5, 2022

(54) RESPONSIVE CONNECTION AND LOCATION OPERATION OF A VAPORIZER DEVICE

(71) Applicant: Pax Labs, Inc., San Francisco, CA (US)

(72) Inventors: Michael Grobler, Redwood City, CA (US); Christina Chiocchi, San Francisco, CA (US); Alexander Fishwick, Monte Sereno, CA (US)

(21) Appl. No.: 17/516,519

(22) Filed: Nov. 1, 2021

Related U.S. Application Data
(60) Provisional application No. 63/108,767, filed on Nov. 2, 2020.

(51) Int. Cl. A24F 40/65; A24F 40/60; A24F 40/53; G08B 7/06

(52) U.S. Cl. CPC A24F 40/65; G08B 7/06; A24F 40/53; A24F 40/60

(57) ABSTRACT

Features relating to tracking location of a vaporizer device and locating a vaporizer device are provided. Tracking location of the vaporizer device and/or locating the vaporizer device may occur through use of an application running on a user device with an established connection/pairing to the vaporizer device. In a connected state, the user device tracks the location of the vaporizer device and may then provide tracked location information through a user interface generated by the application on the user device. The connection between the user device and the vaporizer device enables the user device to locate the vaporizer device as a distance from the user device based on signal strength information. The user device may use the determined distance data to convey, through the user interface, to a user of the user device details related to the current location of the vaporizer device.

### CROSS-REFERENCE TO RELATED APPLICATIONS

The present application claims priority to U.S. Provisional Application No. 63/108,767, filed Nov. 2, 2020, and entitled, “RESPONSIVE CONNECTION AND LOCATION OPERATION OF A VAPORIZER DEVICE,” the entirety of which is incorporated by reference herein.

### TECHNICAL FIELD

The current subject matter described herein relates generally to vaporizer devices, such as portable, personal vaporizer devices for generating and delivering an inhalable aerosol from one or more vaporizable materials, and more particularly relates to vaporizer devices configured to allow for control of an amount of vapor.

### BACKGROUND

Vaporizing devices, including electronic vaporizers or e-vaporizer devices, allow the delivery of vapor and aerosol containing one or more active ingredients by inhalation of the vapor and aerosol. Electronic vaporizer devices are gaining increasing popularity both for prescriptive medical use, in delivering medicaments, and for consumption of nicotine, tobacco, other liquid-based substances, and other plant-based smokeable materials, such as cannabis, including solid (e.g., loose-leaf or flower) materials, solid/liquid (e.g., suspensions, liquid-coated) materials, wax extracts, and prefilled pods (cartridges, wrapped containers, etc.) of such materials. Electronic vaporizer devices in particular may be portable, self-contained, and convenient for use.

### SUMMARY

Aspects of the current subject matter relate to connection and location operation of a vaporizer device. In particular, the current subject matter is directed to aspects of location services that enable tracking location of a vaporizer device and/or locating a vaporizer device through use of an application running on a user device (e.g., a mobile device) with an established connection or pairing to the vaporizer device.

According to some aspects, a method includes generating, in response to an instruction from a user device, an output consistent with output parameters defined in the instruction. The method may also include transmitting, to the user device and in response to a series of signal information requests from the user device, a series of received signal strength indicators and/or power transmit values. The method may further include terminating the output. The terminating of the output may be responsive to one or more of an expiration of a timeout period, a receipt from the user device of a second instruction including a stop command, and a determination of a warning condition of the vaporizer device. The method may also include transmitting, to the user device and in response to the terminating of the output, status information. The status information may include an indicator indicative of the timeout period expiration, the stop command, or the warning condition.

In some aspects, the output includes at least one of a haptic feedback and an animation of one or more light emitting diodes.

In some aspects, the instruction defines the timeout period.

In some aspects, each of the series of received signal strength indicators and/or power transmit values is responsive to a respective one of the series of signal information requests.

In some aspects, the warning condition includes one or more of a low battery level and a temperature warning.

In some aspects, the method also includes disconnecting a connection with the user device responsive to the determination of the warning condition.

In some aspects, the method also includes entering, in response to a lock command from the user device, a locked state during which heater circuitry of the vaporizer device does not respond to a user activation of the vaporizer device.

In some aspects, the method includes determining to connect with the user device responsive to a connection request from the user device. The determination may be based on a previous establishment with the user device.

In some aspects, the method includes generating, in response to a second instruction from the user device, a second output consistent with second output parameters defined in the second instruction.

In some aspects, the method also includes terminating the second output. The terminating of the second output may be responsive to one of the expiration of a second timeout period, receipt from the user device of a third instruction including a second stop command, or a determination of a second warning condition of the vaporizer device.

According to some aspects, a method includes generating, in response to a first instruction from a user device, a first output consistent with first output parameters defined in the first instruction. The method includes transmitting, to the user device and in response to a first signal information request from the user device, a received signal strength indicator and a power transmit value. The method may also include terminating, in response to a determination of expiration of a timeout period, the first output. The timeout period may be defined in the first instruction. The method may also include transmitting, to the user device and in response to the terminating of the first output, a first status information. The first status information includes a timeout expiration indicator. The method may also include generating, in response to a second instruction from the user device, a second output consistent with second output parameters defined in the second instruction. The method may also include terminating, in response to a third instruction from the user device, the second output. The third instruction may include a stop command. The method may further include transmitting, to the user device and in response to the terminating of the second output, a second status information. The second status information includes a stop command indicator.

According to some aspects, a method includes detecting a request to control output of a vaporizer device associated with the apparatus. The request may be initiated via user selection on a user interface provided by the apparatus. In some aspects, the method includes transmitting, to the vaporizer device, a first instruction includes output parameters defining an output for the vaporizer device to generate. The method may also include transmitting, to the vaporizer device, a series of signal information requests. The method may also include determining, in response to each of a series of signal information responses received from the vaporizer device, a distance to the vaporizer device. The distance may be iteratively determined for each of the series of signal information responses such that each of the series of signal information responses corresponds to a respective distance. The method may also include providing, on the user interface, an indication of the distance to the vaporizer device. The user interface may be iteratively updated based on the respective distance associated with each of the series of signal information responses. The method may also include determining to stop the transmission of the series of signal information requests. The determining may be responsive to one of receiving from the vaporizer device status information including a timeout expiration indicator, receiving from the vaporizer device status information including a warning condition indicator, or detecting a stop request initiated via user selection on the user interface. The method may also include providing, on the user interface, an indication corresponding to one of the timeout expiration indicator, the warning condition indicator, or the stop request.

In some aspects, the output includes at least one of a haptic feedback by the vaporizer device and an animation of one or more light emitting diodes from the vaporizer device.

In some aspects, the method includes transmitting, to the vaporizer device and in response to detecting a lock request initiated via user selection on the user interface, a lock command.

In some aspects, the method includes establishing a communication connection with the vaporizer device.

In some aspects, the method includes detecting a second request to control output of the vaporizer device. The second request may be initiated via user selection on the user interface. The method may also include transmitting, to the vaporizer device, a second instruction including second output parameters defining a second output for the vaporizer device to generate.

In some aspects, the indication on the user interface of the distance to the vaporizer device is represented as a ring among a plurality of concentric circles.

According to some aspects, a method includes establishing a communication connection with a vaporizer device. The method also includes identifying, during an active connection state with the vaporizer device, locational data of the vaporizer device. The method further includes determining, upon receiving a request to detect a most recent location of the vaporizer device, an inactive connection state with the vaporizer device. The method also includes providing, on a user interface and responsive to a failure to reconnect with the vaporizer device, an indication of the most recent location of the vaporizer device.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A-FIG. 1F illustrate features of a vaporizer device including a vaporizer body and a cartridge consistent with implementations of the current subject matter;

FIG. 2 is a schematic block diagram illustrating features of a vaporizer device having a cartridge and a vaporizer body consistent with implementations of the current subject matter;

FIG. 3 illustrates communication between a vaporizer device, a user device, and a server consistent with implementations of the current subject matter;

FIG. 4 is a schematic block diagram illustrating features of a vaporizer device consistent with implementations of the current subject matter;

FIG. 5 is a swim lane diagram illustrating aspects of device connection consistent with implementations of the current subject matter;

FIG. 6 is a swim lane diagram illustrating aspects of tracking location of a vaporizer device consistent with implementations of the current subject matter;

FIG. 7A-FIG. 7B are example user interfaces consistent with some implementations of the current subject matter;

FIG. 8 is a swim lane diagram illustrating aspect of locating a vaporizer device consistent with implementations of the current subject matter;

FIG. 9A-FIG. 9L are example user interfaces consistent with implementations of the current subject matter;

FIG. 10 depicts examples of vaporizer device outputs consistent with implementations of the current subject matter;

FIG. 11 is an example of a chart for a process consistent with implementations of the current subject matter; and

FIG. 12 is an example of a chart for another process consistent with implementations of the current subject matter.

When practical, similar reference numbers denote similar structures, features, or elements.

### DETAILED DESCRIPTION

Aspects of the current subject matter relate to location services that enable tracking location of a vaporizer device and locating a vaporizer device through use of an application running on a user device with an established connection or pairing or a previous connection or pairing to the vaporizer device. The user device may be a mobile device or other computing device such as a desktop or laptop computer. The user device and the vaporizer device may enter into a connected state that allows the user device to configure, control, and/or monitor the vaporizer device. For example, the user device may include a mobile application or a web-based application that may be configured to, over a communications connection and upon a connection between the user device and the vaporizer device, control operational aspects of the vaporizer device and/or receive information relating to operation of the vaporizer device 100.

According to aspects of the current subject matter, the connection between the user device and the vaporizer device enables the user device to track the location of the vaporizer device and provide tracked location information through a user interface generated by the application on the user device. For example, locational data representative of a location of the vaporizer device may be identified and provided to the user device, enabling the user device to provide the locational data to a user of the user device. In some implementations, the locational data may be provided regardless of the state of the connection between the user device and the vaporizer device.

Additionally, the connection between the user device and the vaporizer device enables the user device to locate the vaporizer device based on distance and signal strength between the user device and the vaporizer device. For example, in a connected state, the user device may obtain from the vaporizer device signal strength information, and may determine a distance between the user device and the vaporizer device based on the signal strength information. The user device may use the distance data to convey to a user of the user device details related to the current location of the vaporizer device.

Before providing additional details regarding aspects of location and connection operation of a vaporizer device, the following provides a description of some examples of vaporizer devices in which aspects of the current subject matter may be implemented. The following descriptions are meant to be exemplary, and aspects related to the prediction of vapor production by a vaporizer device consistent with the current subject matter are not limited to the example vaporizer devices described herein.

Implementations of the current subject matter include devices relating to vaporizing of one or more materials for inhalation by a user. The term “vaporizer” may be used generically in the following description and may refer to a vaporizer device, such as an electronic vaporizer. Vaporizers consistent with the current subject matter may be referred to by various terms such as inhalable aerosol devices, aerosolizers, vaporization devices, electronic vaping devices, electronic vaporizers, vape pens, etc. Examples of vaporizers consistent with implementations of the current subject matter include electronic vaporizers, electronic cigarettes, e-cigarettes, or the like. In general, such vaporizers are often portable, hand-held devices that heat a vaporizable material to provide an inhalable dose of the material. The vaporizer may include a heater configured to heat a vaporizable material which results in the production of one or more gas-phase components of the vaporizable material. A vaporizable material may include liquid and/or oil-type plant materials, or a semi-solid like a wax, or plant material such as leaves or flowers, either raw or processed. The gas-phase components of the vaporizable material may condense after being vaporized such that an aerosol is formed in a flowing air stream that is deliverable for inhalation by a user. The vaporizers may, in some implementations of the current subject matter, be particularly adapted for use with an oil-based vaporizable material, such as cannabis-derived oils although other types of vaporizable materials may be used as well.

One or more features of the current subject matter, including one or more of a cartridge (also referred to as a vaporizer cartridge or pod) and a reusable vaporizer device body (also referred to as a vaporizer device base, a body, a vaporizer body, or a base), may be employed with a suitable vaporizable material (where suitable refers in this context to being usable with a device whose properties, settings, etc. are configured or configurable to be compatible for use with the vaporizable material). The vaporizable material may include one or more liquids, such as oils, extracts, aqueous or other solutions, etc., of one or more substances that may be desirably provided in the form of an inhalable aerosol. The cartridge may be inserted into the vaporizer body, and then the vaporizable material heated which results in the inhalable aerosol.

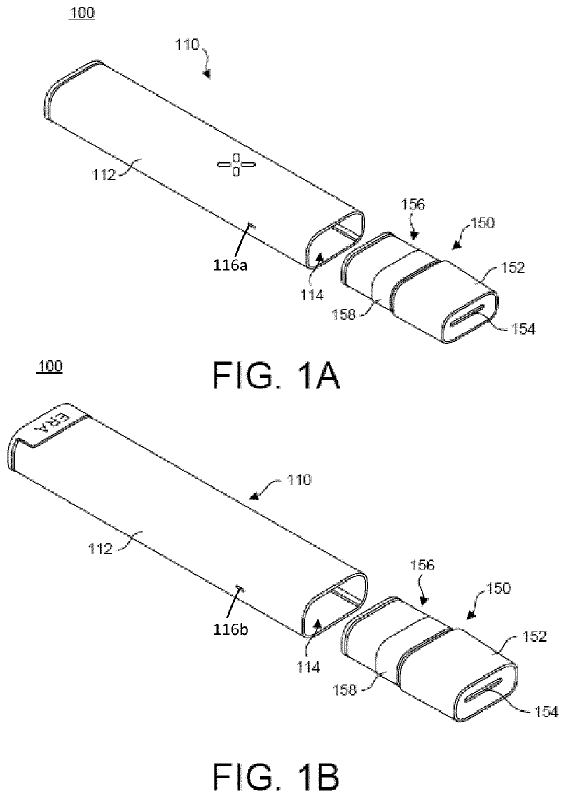

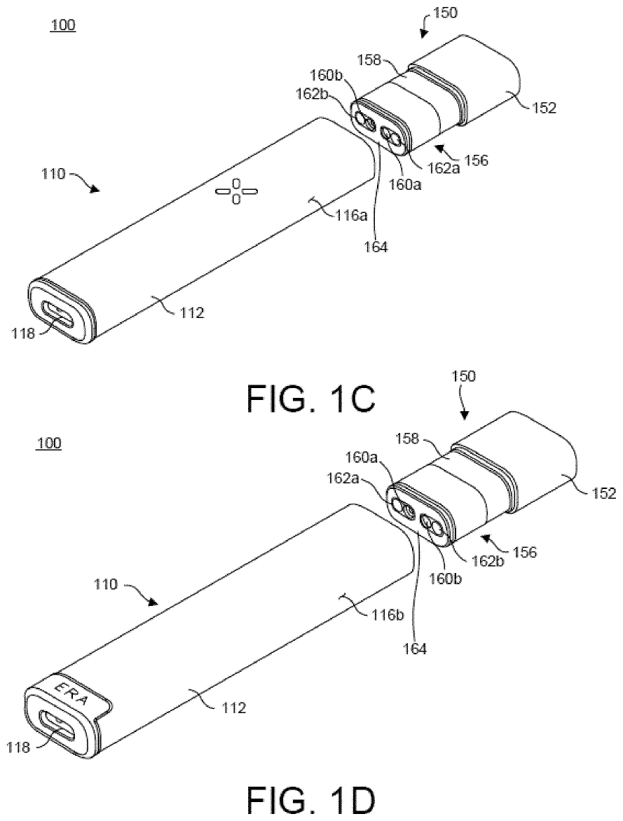

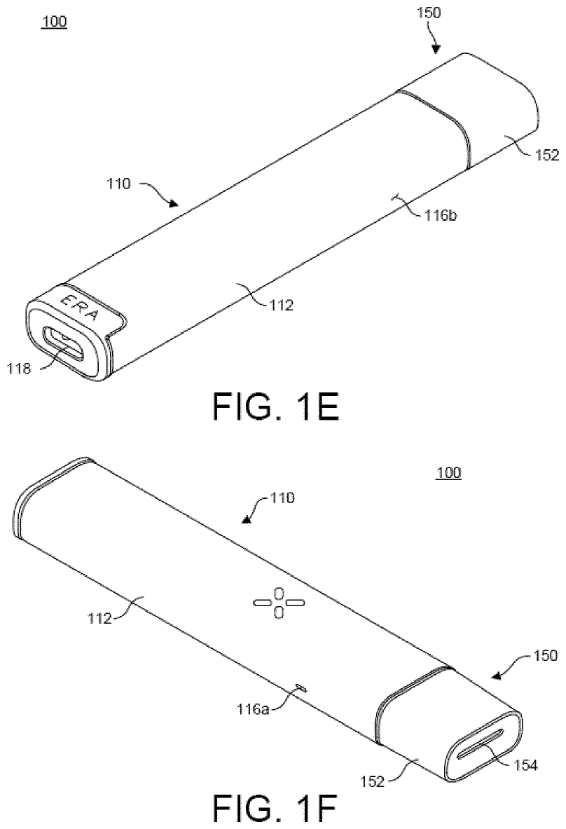

FIG. 1A-FIG. 1F illustrates features of a vaporizer device 100 including a vaporizer body 110 and a cartridge 150 consistent with implementations of the current subject matter. FIG. 1A is a bottom perspective view, and FIG. 1B is a top perspective view of the vaporizer device 100 with the cartridge 150 separated from a cartridge receptacle 114 on the vaporizer body 110. Both of the views in FIG. 1A and FIG. 1B are shown looking towards a mouthpiece 152 of the cartridge 150. FIG. 1C is a bottom perspective view, and FIG. 1D is a top perspective view of the vaporizer device with the cartridge 150 separated from the cartridge receptacle 114 of the vaporizer body 110. FIG. 1C and FIG. 1D are shown looking toward the distal end of the vaporizer body 110. FIG. 1E is top perspective view, and FIG. 1F is a bottom perspective view of the vaporizer device 100 with the cartridge 150 engaged for use with the vaporizer body 110.

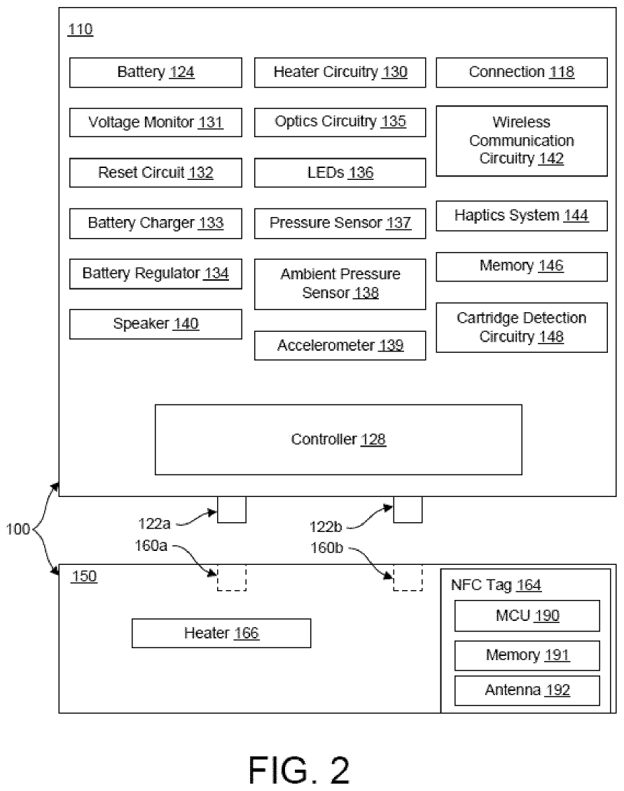

As shown in FIG. 1A-FIG. 1D, the cartridge 150 includes, at the proximal end, a mouthpiece 152 that is attached over a cartridge body 156 that forms a reservoir or tank 158 that holds a vaporizable material. The cartridge body 156 may be transparent, translucent, opaque, or a combination thereof. The mouthpiece 152 may include one or more openings 154 (see FIG. 1A, FIG. 1B, FIG. 1F) at the proximal end out of which vapor may be inhaled, by drawing breath through the vaporizer device 100. The distal end of the cartridge body 156 may couple to and be secured to the vaporizer body 110 within the cartridge receptacle 114 of the vaporizer body 110. Power pin receptacles 160a,b (see FIG. 1C, FIG. 1D) of the cartridge 150 mate with respective power pins or contacts 122a,b (see, for example, FIG. 2) of the vaporizer body 110 that extend into the cartridge receptacle 114. The cartridge 150 also includes air flow inlets 162a,b on the distal end of the cartridge body 156.

A tag 164, such as a data tag, a near-field communication (NFC) tag, or other type of wireless transceiver or communication tag, may be positioned on at least a portion of the distal end of the cartridge body 156. As shown in FIG. 1C and FIG. 1D, the tag 164 may substantially surround the power pin receptacles 160a,b and the air flow inlets 162a,b, although other configurations of the tag 164 may be implemented as well. For example, the tag 164 may be positioned between the power pin receptacle 160a and the power pin receptacle 160b, or the tag 164 may be shaped as a circle, partial circle, oval, partial oval, or any polygonal shape encircling or partially encircling the power pin receptacles 160a,b and the air flow inlets 162a,b or a portion thereof.

In the example of FIG. 1A, the vaporizer body 110 has an outer shell or cover 112 that may be made of various types of materials, including for example aluminum (e.g., AL6063), stainless steel, glass, ceramic, titanium, plastic (e.g., Acrylonitrile Butadiene Styrene (ABS), Nylon, Polycarbonate (PC), Polyethersulfone (PESU), and the like), fiberglass, carbon fiber, and any hard, durable material. The proximal end of the vaporizer body 110 includes an opening forming the cartridge receptacle 114, and the distal end of the vaporizer body 110 includes a connection 118, such as, for example, a universal serial bus Type C (USB-C) connection and/or the like. The cartridge receptacle 114 portion of the vaporizer body 110 includes one or more openings (air inlets) 116a,b that extend through the outer shell 112 to allow airflow therein, as described in more detail below. The vaporizer body 110 as shown has an elongated, flattened tubular shape that is curvature-continuous, although the vaporizer body 110 is not limited to such a shape. The vaporizer body 110 may take the form of other shapes, such as, for example, a rectangular box, a cylinder, and the like.

The cartridge 150 may fit within the cartridge receptacle 114 by a friction fit, snap fit, and/or other types of secure connection. The cartridge 150 may have a rim, ridge, protrusion, and/or the like for engaging a complimentary portion of the vaporizer body 110. While fitted within the cartridge receptacle 114, the cartridge 150 may be held securely within but still allow for being easily withdrawn to remove the cartridge 150.

Although FIG. 1A-FIG. 1F illustrate a certain configuration of the vaporizer device 100, the vaporizer device 100 may take other configurations as well.

FIG. 2 is a schematic block diagram illustrating components of the vaporizer device 100 having the cartridge 150 and the vaporizer body 110 consistent with implementations of the current subject matter. Included in the vaporizer body 110 is a controller 128 that includes at least one processor and/or at least one memory configured to control and manage various operations among the components of the vaporizer device 100 described herein.

Heater control circuitry 130 of the vaporizer body 110 controls a heater 166 of the cartridge 150. The heater 166 may generate heat to provide vaporization of the vaporizable material. For example, the heater 166 may include a heating coil (e.g., a resistive heater) in thermal contact with a wick which absorbs the vaporizable material, as described in further detail below.

A battery 124 is included in the vaporizer body 110, and the controller 128 may control and/or communicate with a voltage monitor 131 which includes circuitry configured to monitor the battery voltage, a reset circuit 132 configured to reset (e.g., shut down the vaporizer device 100 and/or restart the vaporizer device 100 in a certain state), a battery charger 133, and a battery regulator 134 (which may regulate the battery output, regulate charging/discharging of the battery, and provide alerts to indicate when the battery charge is low, etc.).

The power pins 122a,b of the vaporizer body 110 engage the complementary power pin receptacles 160a,b of the cartridge 150 when the cartridge 150 is engaged with the vaporizer body 110. Alternatively, power pins may be part of the cartridge 150 for engaging complementary power pin receptacles of the vaporizer body 110. The engagement allows for the transfer of energy from an internal power source (e.g., the battery 124) to the heater 166 in the cartridge 150. The controller 128 may regulate the power flow (e.g., an amount or current and/or a voltage amount) to control a temperature at which the heater 166 heats the vaporizable material contained in the reservoir 158. According to implementations of the current subject matter, a variety of electrical connectors other than a pogo-pin and complementary pin receptacle configuration may be used to electrically connect the vaporizer body 110 and the cartridge 150, such as for example, a plug and socket connector.

The controller 128 may control and/or communicate with optics circuitry 135 (which controls and/or communicates with one or more displays such as LEDs 136 which may provide user interface output indications), a pressure sensor 137, an ambient pressure sensor 138, an accelerometer 139, and/or a speaker 140 configured to generate sound or other feedback to a user.

The pressure sensor 137 may be configured to sense a user drawing (i.e., inhaling) on the mouthpiece 152 and activate the heater control circuitry 130 of the vaporizer body 110 to accordingly control the heater 166 of the cartridge 150. In this way, the amount of current supplied to the heater 166 may be varied according the user's draw (e.g., additional current may be supplied during a draw, but reduced when there is not a draw taking place). The ambient pressure sensor 138 may be included for atmospheric reference to reduce sensitivity to ambient pressure changes and may be utilized to reduce false positives potentially detected by the pressure sensor 137 when measuring draws from the mouthpiece 152.

The accelerometer 139 (and/or other motion sensors, capacitive sensors, flow sensors, strain gauge(s), or the like) may be used to detect user handling and interaction, for example, to detect movement of the vaporizer body 110 (such as, for example, tapping, rolling, and/or any other deliberate movement associated with the vaporizer body 110).

The vaporizer body 110, as shown in FIG. 2, includes wireless communication circuitry 142 that is connected to and/or controlled by the controller 128. The wireless communication circuitry 142 may include a near-field communication (NFC) antenna that is configured to read from and/or write to the tag 164 of the cartridge 150. Alternatively or additionally, the wireless communication circuitry 142 may be configured to automatically detect the cartridge 150 as it is being inserted into the vaporizer body 110. In some implementations, data exchanges between the vaporizer body 110 and the cartridge 150 take place over NFC. In some implementations, data exchanges between the vaporizer body 110 and the cartridge 150 may take place via a wired connection such as various wired data protocols.

The wireless communication circuitry 142 may include additional components including circuitry for other communication technology modes, such as Bluetooth circuitry, Bluetooth Low Energy circuitry, Wi-Fi circuitry, cellular (e.g., LTE, 4G, and/or 5G) circuitry, and associated circuitry (e.g., control circuitry), for communication with other devices. For example, the vaporizer body 110 may be configured to wirelessly communicate with a remote processor (e.g., a smartphone, a tablet, a computer, wearable electronics, a cloud server, and/or processor based devices) through the wireless communication circuitry 142, and the vaporizer body 110 may through this communication receive information including control information (e.g., for setting temperature, resetting a dose counter, etc.) from and/or transmit output information (e.g., dose information, operational information, error information, temperature setting information, charge/battery information, etc.) to one or more of the remote processors.

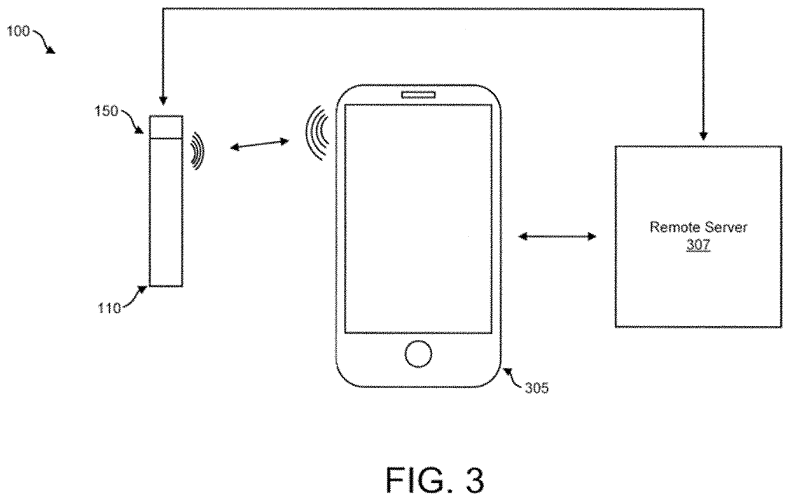

The tag 164 may be a type of wireless transceiver and may include a microcontroller unit (MCU) 190, a memory 191, and an antenna 192 (e.g., an NFC antenna) to perform the various functionalities described below with further reference to FIG. 3. NFC tag 164 may be, for example, a 1 Kbit or a 2 Kbit tag that is of type ISO/IEC 15693. NFC tags with other specifications may also be used. The tag 164 may be implemented as active NFC, enabling reading and/or writing information via NFC with other NFC compatible devices including a remote processor, another vaporizer device, and/or wireless communication circuitry 142. Alternatively, the tag 164 may be implemented using passive NFC technology, in which case other NFC compatible devices (e.g., a remote processor, another vaporizer device, and/or wireless communication circuitry 142) may only be able to read information from the tag 164.

The vaporizer body 110 may include a haptics system 144, such as an actuator, a linear resonant actuator (LRA), an eccentric rotating mass (ERM) motor, or the like that provide haptic feedback such as a vibration as a “find my device” feature or as a control or other type of user feedback signal. For example, using an app running on a user device (such as, for example, a user device 305 shown in FIG. 3), a user may indicate that he/she cannot locate his/her vaporizer device 100. Through communication via the wireless communication circuitry 142, the controller 128 sends a signal to the haptics system 144, instructing the haptics system 144 to provide haptic feedback (e.g., a vibration). The controller 128 may additionally or alternatively provide a signal to the speaker 140 to emit a sound or series of sounds. The haptics system 144 and/or speaker 140 may also provide control and usage feedback to the user of the vaporizer device 100; for example, providing haptic and/or audio feedback when a particular amount of a vaporizable material has been used or when a period of time since last use has elapsed. Alternatively or additionally, haptic and/or audio feedback may be provided as a user cycles through various settings of the vaporizer device 100. Alternatively or additionally, the haptics system 144 and/or speaker 140 may signal when a certain amount of battery power is left (e.g., a low battery warning and recharge needed warning) and/or when a certain amount of vaporizable material remains (e.g., a low vaporizable material warning and/or time to replace the cartridge 150). Alternatively or additionally, the haptics system 144 and/or speaker 140 may also provide usage feedback and/or control of the configuration of the vaporizer device 100 (e.g., allowing the change of a configuration, such as target heating rate, heating rate, etc.).

The vaporizer body 110 may include circuitry for sensing/detecting when a cartridge 150 is connected and/or removed from the vaporizer body 110. For example, cartridge-detection circuitry 148 may determine when the cartridge 150 is connected to the vaporizer body 110 based on an electrical state of the power pins 122a,b within the cartridge receptacle 114. For example, when the cartridge 150 is present, there may be a certain voltage, current, and/or resistance associated with the power pins 122a,b, when compared to when the cartridge 150 is not present. Alternatively or additionally, the tag 164 may also be used to detect when the cartridge 150 is connected to the vaporizer body 110.

The vaporizer body 110 also includes the connection (e.g., USB-C connection, micro-USB connection, and/or other types of connectors) 118 for coupling the vaporizer body 110 to a charger to enable charging the internal battery 124. Alternatively or additionally, electrical inductive charging (also referred to as wireless charging) may be used, in which case the vaporizer body 110 would include inductive charging circuitry to enable charging. The connection 118 at FIG. 2 may also be used for a data connection between a computing device and the controller 128, which may facilitate development activities such as, for example, programming and debugging, for example.

The vaporizer body 110 may also include a memory 146 that is part of the controller 128 or is in communication with the controller 128. The memory 146 may include volatile and/or non-volatile memory or provide data storage. In some implementations, the memory 146 may include 8 Mbit of flash memory, although the memory is not limited to this and other types of memory may be implemented as well.

FIG. 3 illustrates communication between the vaporizer device 100 (including the vaporizer body 110 and the cartridge 150), the user device 305 (e.g., a smartphone, tablet, laptop, desktop computer, a workstation, and/or the like), and a remote server 307 (e.g., a server coupled to a network, a cloud server coupled to the Internet, and/or the like) consistent with implementations of the current subject matter. The user device 305 wirelessly communicates with the vaporizer device 100. A remote server 307 may communicate directly with the vaporizer device 100 or through the user device 305. The vaporizer body 110 may communicate with the user device 305 and/or the remote server 307 through the wireless communication circuitry 142. In some implementations, the cartridge 150 may establish through the tag 164 communication with the vaporizer body 110, the user device 305, and/or the remote server 307. While the user device 305 in FIG. 3 is depicted as a type of handheld mobile device, the user device 305 consistent with implementations of the current subject matter is not so limited and may be, as indicated, various other types of user computing devices.

An application software (“app”) running on at least one of the remote processors (the user device 305 and/or the remote server 307) may be configured to control operational aspects of the vaporizer device 100 and receive information relating to operation of the vaporizer device 100. For example, the app may provide a user with capabilities to input or set desired properties or effects, such as, for example, a particular temperature or desired dose, which is then communicated to the controller 128 of the vaporizer body 110 through the wireless communication circuitry 142. The app may also provide a user with functionality to select one or more sets of suggested properties or effects that may be based on the particular type of vaporizable material in the cartridge 150. For example, the app may allow adjusting heating based on the type of vaporizable material, the user's (of the vaporizer device 100) preferences or desired experience, and/or the like. The app may be a mobile app and/or a browser-based or web app. For example, the functionality of the app may be accessible through one or more web browsers running on one or more types of user computing devices.

Data read from the tag 164 from the wireless communication circuitry 142 of the vaporizer body 110 may be transferred to one or more of the remote processors (e.g., the user device 305 and/or the remote server 307) to which it is connected, which allows for the app running on the one or more processors to access and utilize the read data for a variety of purposes. For example, the read data relating to the cartridge 150 may be used for providing recommended temperatures, dose control, usage tracking, and/or assembly information.

The cartridge 150 may also communicate directly, through the tag 164, with other devices. This enables data relating to the cartridge 150 to be written to/read from the tag 164, without interfacing with the vaporizer body 110. The tag 164 thus allows for identifying information (e.g., pod ID, batch ID, etc.) related to the cartridge 150 to be associated with the cartridge 150 by one or more remote processors. For example, when the cartridge 150 is filled with a certain type of vaporizable material, this information may be transmitted to the tag 164 by filling equipment. Then, the vaporizer body 110 is able to obtain this information from the tag 164 (e.g., via the wireless communication circuitry 142 at the vaporizer body 110) to identify the vaporizable material currently being used and accordingly adjust the controller 128 based on, for example, user-defined criteria or pre-set parameters associated with the particular type of vaporizable material (set by a manufacturer or as determined based upon user experiences/feedback aggregated from other users). For example, a user may establish (via the app) a set of criteria relating to desired effects for or usage of one or more types of vaporizable materials. When a certain vaporizable material is identified, based on communication via the tag 164, the controller 128 may accordingly adopt the established set of criteria, which may include, for example, temperature and dose, for that particular vaporizable material.

Consistent with implementations of the current subject matter, the vaporizable material used with the vaporizer device may be provided within the cartridge. The vaporizer device may be a cartridge-using vaporizer device, a cartridge-less vaporizer device, or a multi-use vaporizer device capable of use with or without a cartridge. For example, a multi-use vaporizer device may include a heating chamber (e.g., an oven) configured to receive the vaporizable material directly in the heating chamber and also configured to receive the cartridge having a reservoir or the like for holding the vaporizable material. In various implementations, the vaporizer device may be configured for use with liquid vaporizable material (e.g., a carrier solution in which an active and/or inactive ingredient(s) are suspended or held in solution or a liquid form of the vaporizable material itself) or solid vaporizable material. Solid vaporizable material may include a plant material that emits some part of the plant material as the vaporizable material (e.g., such that some part of the plant material remains as waste after the vaporizable material is emitted for inhalation by a user) or optionally may be a solid form of the vaporizable material itself such that all of the solid material may eventually be vaporized for inhalation. Liquid vaporizable material may likewise be capable of being completely vaporized or may include some part of the liquid material that remains after all of the material suitable for inhalation has been consumed.

As described above, the vaporizer device 100 and/or the user device 305 that is part of a vaporizer system as defined above may include a user interface (e.g., including an app or application software) that may be executed on the user device 305 in communication, which may be configured to determine, display, enforce, and/or meter dosing.

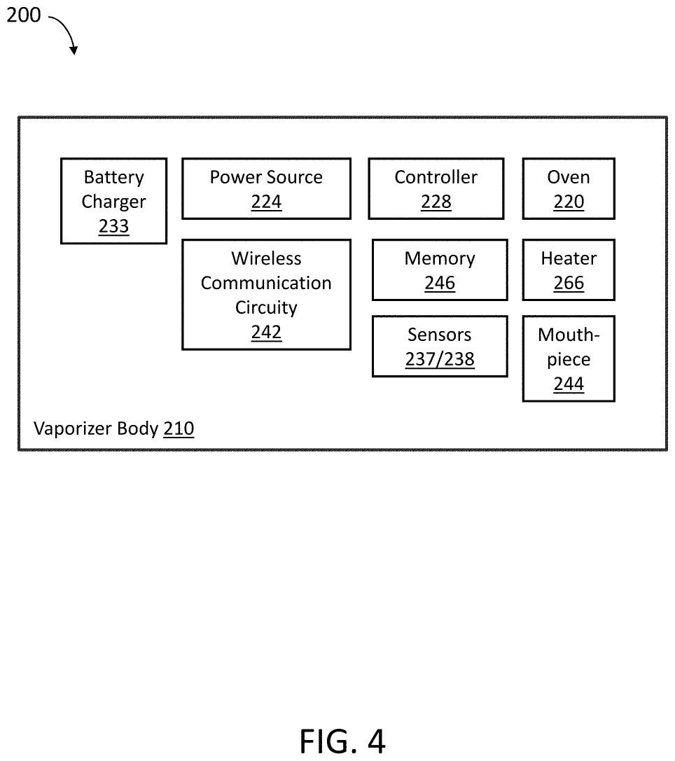

FIG. 4 is a schematic block diagram illustrating features of another vaporizer device 200 consistent with implementations of the current subject matter. The vaporizer device 200 does not require use of a cartridge (but may still optionally accept a cartridge), but may instead use a loose-leaf material. The vaporizer device 200 in FIG. 4 includes an oven 220 (e.g., vaporization chamber) in which loose vaporizable material may be placed. Many of the same elements present in the vaporizer device 100 using cartridge 150 shown in FIG. 1A-FIG. 1F and FIG. 2 may also be included as part of the vaporizer device 200. For example, the vaporizer device 200 may include a vaporizer body 210 with controller 228, wireless communication circuitry 242, and/or memory 246. A power source 224 (e.g., battery, capacitor, etc.) may be charged by a battery charger 233 (and may include charging control circuitry, not shown). The vaporizer device 200 may also include one or more sensors 237, 238. In addition, the vaporizer device 200 may include one or more heaters 266 that heat the oven 220. The heater 266 may be controlled using the resistance of the heater 266 to determine the temperature of the heater, e.g., by using the temperature coefficient of resistivity for the heater 266. Convection heating methods may be used. A mouthpiece 244 is also included.

Software, firmware, or hardware that is separate or separable from the vaporizer device and that wirelessly communicates with the vaporizer device may be provided as described with respect to FIG. 3. For example, applications (“apps”) may be executed on a processor of a portable and/or wearable device, including smartphones, smartwatches, and the like, which may be referred to as a personal digital device, a user device, or optionally just a device (e.g., user device 305 in FIG. 3) that is part of a connected system. These digital devices may provide an interface for the user to engage and interact with functions related to the vaporizer device, including communication of data to and from the vaporizer device to the digital device or the like and/or additional third party processor (e.g., servers such as the remote server 307 in FIG. 3). For example, a user may control some aspects of the vaporizer device (temperature, session size, etc.) and/or data transmission and data receiving to and from the vaporizer device, optionally over a wireless communication channel between first communication hardware of the digital device and second communication hardware of the vaporizer device. Data may be communicated in response to one or more actions of the user (e.g., including interactions with a user interface displayed on the device), and/or as a background operation such that the user does not have to initiate or authorize the data communication process.

User interfaces may be deployed on the digital device and may aid the user in operating the vaporizer device. For example, the user interface operating on the digital device may include icons and text elements that may inform the user of various ways that vaporizer settings may be adjusted or configured by the user. In this manner (or in others consistent with the current subject matter) information about the vaporizer device may be presented using a user interface displayed by the digital device. Icons and/or text elements may be provided to allow the user to see information regarding one or more statuses of the vaporizer device, such as battery information (charge remaining, draws remaining, time to charge, charging, etc.), cartridge status (e.g., type of cartridge and vaporizable material, fill status of cartridge, etc.), and other device statuses or information. Icons and/or text elements may be provided to allow the user to update internal software (a.k.a., firmware) in the vaporizer device. Icons and text elements may be provided to allow the user to set security and/or authorization features of the vaporizer device, such as setting a PIN code to activate the vaporizer device or the use of personal biometric information as a way of authentication. Icons and text elements may be provided to allow the user to configure foreground data sharing and related settings.

The vaporizer device may perform onboard data gathering, data analysis, and/or data transmission methods. As mentioned, the vaporizer device having wired or wireless communication capability may interface with digital consumer technology products such as smart phones, tablet computers, laptop/netbook/desktop computers, wearable wireless technologies such as “smart watches,” and other wearable technology such as Google “Glass,” or similar through the use of programming, software, firmware, GUI, wireless communication, wired communication, and/or software commonly referred to as application(s) or “apps.” A wired communication connection may be used to interface the vaporizer device to digital consumer technology products for the purpose of the transmission and exchange of data to/from the vaporizer device from/to the digital consumer technology products (and thereby also interfacing with apps running on the digital consumer technology products). A wireless communication connection may be used to interface the vaporizer device to digital consumer technology products for the transmission and exchange of data to/from the vaporizer device from/to the digital wireless interface. The vaporizer device may use a wireless interface that includes one or more of an infrared (IR) transmitter, a Bluetooth interface, an 802.11 specified interface, and/or communications with a cellular telephone network in order to communicate with consumer technology.

Aspects of the current subject matter relating to connection and location operation of a vaporizer device are not limited to use with the particular and/or exact configurations and/or components of the vaporizer device 100, the vaporizer body 110, the cartridge 150, and the vaporizer device 200 described with reference to FIG. 1A-FIG. 4. Rather, the foregoing descriptions are provided as examples in which the described aspects may be utilized. Variations of the example vaporizer devices described herein may be used with aspects of the current subject matter directed to connection and location operation. For example, in some implementations, a single-use integrated vaporizer device may employ the aspects of the current subject matter. Aspects of the current subject matter may be employed with various other vaporizer devices, vaporizer bodies, and cartridges and/or with various modifications of the vaporizer device 100, the vaporizer body 110, the cartridge 150, and the vaporizer device 200 described herein. For example, consistent with implementations of the current subject matter, various sensors and circuitry may not be required for the operations provided herein. For example, the ambient pressure sensor 138 and the accelerometer 139 may not be required in some implementations. Various other combinations of configurations and/or components of the vaporizer device 100, the vaporizer body 110, the cartridge 150, and the vaporizer device 200 may be employed consistent with implementations of the current subject matter.

Additionally, while some implementations of the current subject matter may be described with respect to cannabis and cannabinoid-based vaporizable materials, for example cannabis oils, the disclosure is not limited to cannabis and cannabinoid-based vaporizable materials and may be applicable to other types of materials.

Turning to aspects of location services for a vaporizer device that include tracking location of a vaporizer device and locating a vaporizer device, according to aspects of the current subject matter a connection is established between the user device 305 and the vaporizer device 100. The connection may include creating an association between the user device 305 and the vaporizer device 100 such that the user device 305 and the vaporizer device 100 mutually agree to establishing a connection between each other for communication and data exchange. In some implementations, the connection includes an active connection state established between the user device 305 and the vaporizer device 100 for communication and data exchange therebetween. The active communication state may include a wireless connection between the user device 305 and the vaporizer device 100. The association between the user device 305 and the vaporizer device 100 may allow for re-establishing the connection if the connection is lost.

Consistent with implementations of the current subject matter, the association may be such that the user device 305 stores identification data, control data, and operational data of the vaporizer device 100, and the identification data, the control data, and the operational data that is stored is available to the user device 305 during both active and inactive connection states between the user device 305 and the vaporizer device 100. For example, in an inactive connection state, the user device 305 and the vaporizer device 100 may be separated at such a distance that communication between the user device 305 and the vaporizer device 100 is not feasible or possible; or the active connection state may be disabled or lost. In addition to the user device 305, the remote server 307 may also store the identification data, the control data, and the operational data of the vaporizer device 100. Moreover, while the user device 305 may store the control data and the operational data for a predetermined period of time, the remote server 307 may store a complete record or a subset thereof greater than that stored by the user device 305. The user device 305 may access historical data from the remote server 307 for the connection and location operations consistent with implementations of the current subject matter.

Consistent with implementations of the current subject matter, messaging between the user device 305 and the vaporizer device 100 may be in accordance with a standard, such as Bluetooth, or Bluetooth Low Energy (BLE) as defined by, for example, Bluetooth Special Interest Group, Bluetooth Core Specification v5.1, Jan. 21, 2019, hereinafter the “Bluetooth Specification”). Other peer-to-peer technology or low-power wireless protocols may be used as well, such as low rate personal area networks, Zigbee, 6LoWPAN, SNAP, and the like as defined by IEEE 802.15.4v-2017—IEEE Standard for Low-Rate Wireless Networks—Amendment 5: Enabling/Updating the Use of Regional Sub-GHz Bands. Communication to and from the vaporizer device 100 may be through the wireless communication circuitry 142 described with reference to FIG. 2.

According to aspects of the current subject matter, any number of vaporizer devices may be bound to or associated with the user device 305 at any given time. As such, the user device 305 may store (e.g., locally and/or in non-volatile memory), a binding record associated with each vaporizer device.

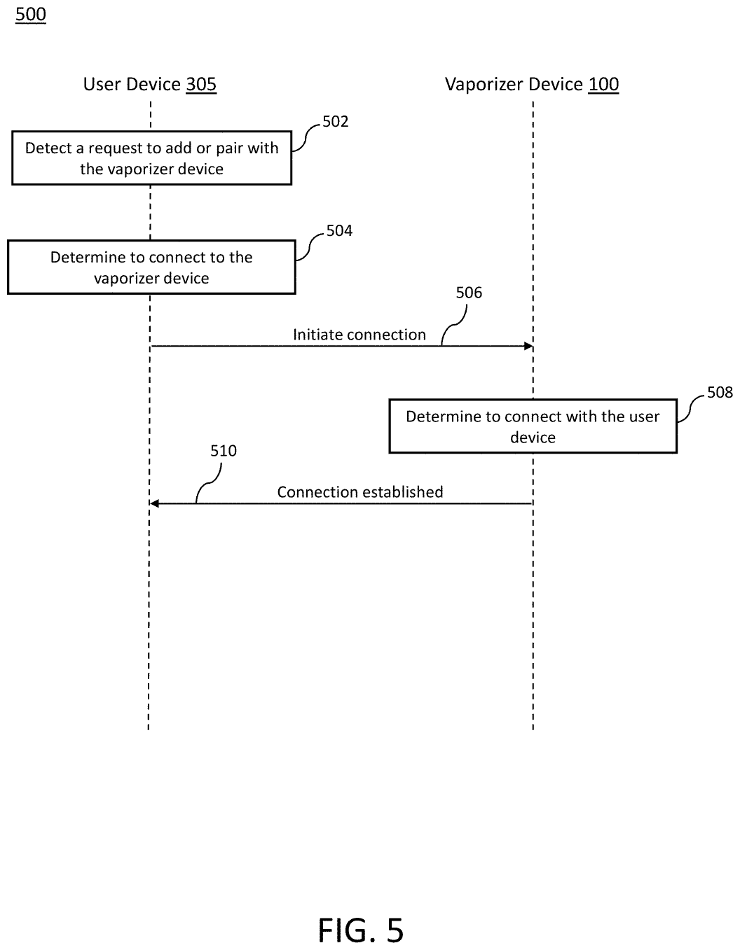

FIG. 5 depicts a swim lane diagram 500 illustrating aspects of establishing a connection between the user device 305 and the vaporizer device 100 consistent with implementations of the current subject matter. In particular, the swim lane diagram 500 depicts operations of and communication between the user device 305 and the vaporizer device 100.

At 502, a request is detected at the user device 305 to add and/or pair with the vaporizer device 100. A user may initiate, through a user interface generated by an application, such as a mobile application or a web-based application, running on the user device 305, the request to add and/or pair with the vaporizer device 100. An indication of the vaporizer device 100, as well as other devices within range of the user device 305, may be presented on a user interface for selection. In some implementations, the request to add and/or pair may be initiated through the vaporizer device 100. For example, the user may move the vaporizer device 100 in a preconfigured movement (e.g., a shaking motion, a tapping motion) that initiates a connection between the user device 305 if the user device 305 is within range (e.g., connection range) of the vaporizer device 100. The vaporizer device 100 may wirelessly transmit one or more advertisement messages as a broadcast to enable discovery by the user device 305, which can establish a connection with the vaporizer device 100.

At 504, the user device 305 determines to connect to the vaporizer device 100. In an implementation, in response to receiving the advertisement message, the user device 305 (or the application therein) may determine, at 504, to connect to the vaporizer device 100. The determination may be based on the contents of the advertisement message (e.g., identifying data contained in the advertisement message or other data in the advertisement message). The user device 305 may determine that the advertisement includes a serial number, a model number, manufacturer-specific data, and/or other information that the user device 305 recognizes as conforming to an expected format, value, and/or range of values. The user device 305 may display, on the user interface, at least some of the identification data from the advertisement message, and may detect a user selection to connect to the vaporizer device 100. The user device 305 may locally store at least some of the identification data included in the advertisement message. For example, if the advertisement message includes a device serial number, the user device 305 may locally store the device serial number. The user device 305 may later determine, based on the locally stored identification data, whether to re-establish a connection with the vaporizer device 100.

At 506, upon determining to connect to the vaporizer device 100, the user device 305 transmits to the vaporizer device 100 an initiate connection message. The initiate connection message may serve as a notification to the vaporizer device 100 that the request detected at the user device 305 to add and/or pair with the vaporizer device 100 is acknowledged and/or accepted. The initiate connection message may also include any data or information that is necessary for the vaporizer device 100 to verify the user device 305, for example user device identification and/or verification data and/or one or more portions of the content of the advertisement message that was sent by the vaporizer device 100.

At 508, in response to receiving the initiate connection message, the vaporizer device 100 determines to connect with the user device 305. The determination may be based on the contents of the initiate connection message (e.g., identifying data contained in the initiate connection message or other data in the initiate connection message). The vaporizer device 100 may determine that the initiate connection message includes information that the vaporizer device 100 recognizes as conforming to an expected format, value, and/or range of values.

At 510, upon determining to connect with the user device 305, the vaporizer device 100 transmits to the user device 305 a connection established message. After discovering and connecting with the vaporizer device 100, the user device's application (e.g., mobile and/or web-based application) may allow the user device 305 (or its associated user) to configure, control, and/or monitor the vaporizer device 100.

According to aspects of the current subject matter, a location of the vaporizer device 100 may be identified and tagged to track the location of the vaporizer device 100 and provide tracked location information to a user. Locational data representative of the location of the vaporizer device 100 may be received by a receiver of the vaporizer device 100 and/or the user device 305. For example, the vaporizer device 100 and/or the user device 305 may receive global positioning system (GPS) data or other locational data from one or more GPS and locational data sources. In some implementations, the GPS data or other locational data may be received from a cellular network through the wireless communication circuitry 142. In some implementations, locational data may be inputted by a user. For example, a user of the user device 305 may input an address or other identifiable location, and the address or other identifiable location may be associated with the vaporizer device 100.

The locational data representative of the location of the vaporizer device 100 may be provided to the user device 305, enabling the user device 305 to store and display the locational data to a user of the user device 305. In some implementations, the locational data representative of the location of the vaporizer device 100 may be determined based on a connection with the user device 305. For example, if the user device 305 and the vaporizer device 100 are in an active connection state, the user device 305 may track the location of the vaporizer device 100 as being the same or substantially equivalent to that of the user device 305; thus locational data related to the user device 305 (e.g., GPS data received by a receiver of the user device 305) may be applicable to that of the vaporizer device 100.

The locational data may be periodically updated, for example at a given time interval, or updated upon identification of a new location different from a previous location. Time and date data may be associated with the locational data. The time and date data may be received by the vaporizer device 100 and/or the user device 305 with the locational data. For example, the time during which the vaporizer device 100 was at the location represented by the locational data may be associated with the locational data. When the locational data is updated, a time and date stamp indicating the time and date of the update may be associated with the locational data. The user device 305 may store the locational data and the associated time and date data (or a subset thereof), and provide the locational data and the associated time and date data (or a subset thereof) to the remote server 307. The locational data, consistent with implementations of the current subject matter, allows the user device 305 to provide tracked location information through a user interface generated by the application on the user device 305.

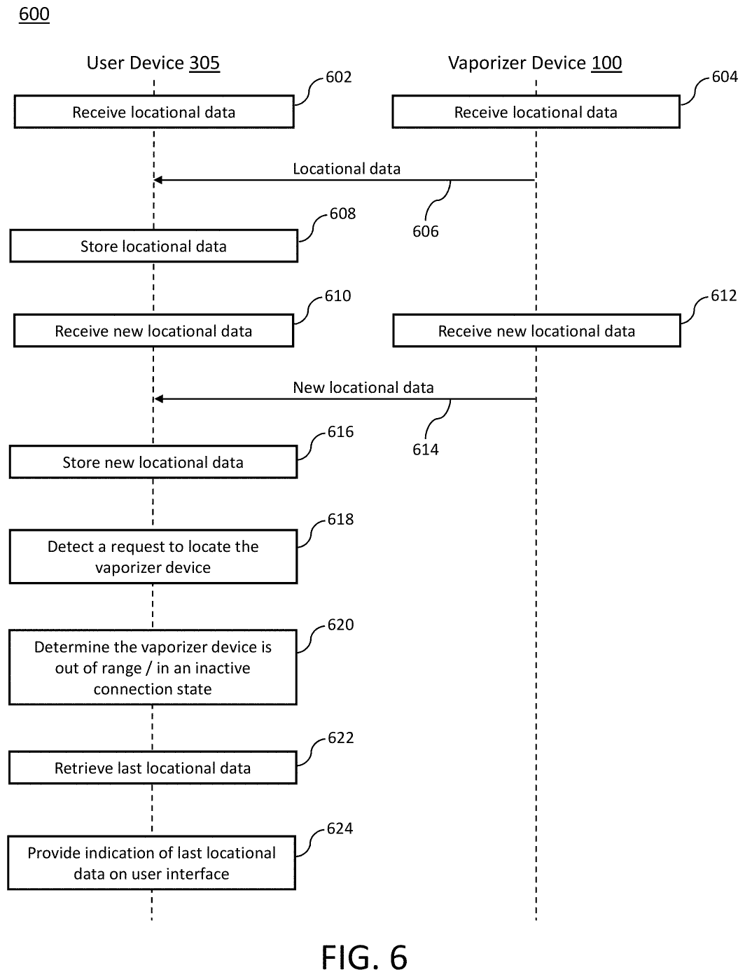

FIG. 6 depicts a swim lane diagram 600 illustrating aspects related to tracking a location of a vaporizer device consistent with implementations of the current subject matter. In particular, the swim lane diagram 600 depicts operations of and communication between the user device 305 and the vaporizer device 100. The operations in the swim lane diagram 600 may follow after the operations for establishing a connection between the user device 305 and the vaporizer device 100, as described with reference to the swim lane diagram 500 of FIG. 5.

At 602, the user device 305 may receive locational data. For example, the user device 305 may receive, through a receiver, GPS data indicative of the location of the user device 305. At 604, in some implementations, the vaporizer device 100 may also receive, through a receiver, locational data. In some implementations, the locational data representative of the location of the vaporizer device 100 is determined based on a connection with the user device 305. For example, if the user device 305 and the vaporizer device 100 are in an active connection state, the user device 305 may track the location of the vaporizer device 100 as being the same or substantially equivalent to that of the user device 305; thus the locational data related to the user device 305 may be applicable to (e.g., the same as) that of the vaporizer device 100.

At 606, in some implementations, the vaporizer device 100 transmits its locational data to the user device 305. At 608, the user device 305 stores the received locational data, which may include the locational data received from the vaporizer device 100 and/or the locational data of the user device 305.

At 610, the user device 305 may receive updated or new locational data representative of the location of the user device 305. At 612, in some implementations, the vaporizer device 100 may also receive updated or new locational data. As previously described, the vaporizer device 100 may not directly receive locational data; rather, the user device 305 may associate its location with that of the vaporizer device 100 if the user device 305 and the vaporizer device 100 are in an active connection state.

At 614, in some implementations, the vaporizer device 100 transmits its updated or new locational data to the user device 305. At 616, the user device 305 stores the received updated or new locational data, which may include the updated or new locational data received from the vaporizer device 100 and/or the updated or new locational data of the user device 305. The process of the user device 305 and/or the vaporizer device 100 receiving locational data and of the user device 305 storing the locational data may occur at various predefined intervals and/or upon determination of the previous locational data changing.

At 618, the user device 305 detects a request to locate the vaporizer device 100. A user may initiate, through a user interface generated by an application running on the user device 305, the request. According to aspects of the current subject matter, as the user device 305 is receiving locational data representative of the location of the vaporizer device 100, the user device 305 may obtain the most recent locational data, and associated time data, and provide the data over the user interface of the user device 305.

At 620, in some implementations, the user device 305 may determine if the vaporizer device 100 is out of range with the user device 305 such that an active connection between the user device 305 and the vaporizer device 100 is not established. The user device 305 may additionally or alternatively determine if an inactive connection state exists between the user device 305 and the vaporizer device 100. According to some implementations of the current subject matter, the user device 305 may check the connection state to determine if more recent locational data may be available. If the connection state is such that the user device 305 and the vaporizer device 100 are not within range of one another and/or there is an inactive connection state, the user device 305, in order to respond to the request to locate the vaporizer device 100, may rely on the most recently stored locational data.

At 622, in response to a determination that the vaporizer device 100 is out of range (e.g., a failure to reconnect) with the user device 305 and/or that an inactive connection state exists between the user device 305 and the vaporizer device 100, the user device 305 may retrieve the last (e.g., most recent) locational data for the vaporizer device 100. In some implementations, the last (e.g., most recent) locational data for the vaporizer device 100 may be the locational data received by the user device 305 during an active connection state with the vaporizer device 100.

At 624, upon retrieving the last (e.g., most recent) locational data for the vaporizer device 100, the user device 305 may respond by providing an indication of the last locational data on the user interface of the user device 305. For example, the application running on the user device 305 may generate a user interface that includes the locational data as well as other information that may be relevant, including the time data associated with the locational data, a name of the location, and/or a duration of the time at the location. In some implementations, the name of the location may be identified by comparing an address of the location with data stored at the user device 305 and/or at the remote server 307. For example, a contact or a business with address information may be retrieved and provided on the user interface. Additional controls and options may also be provided on the user interface.

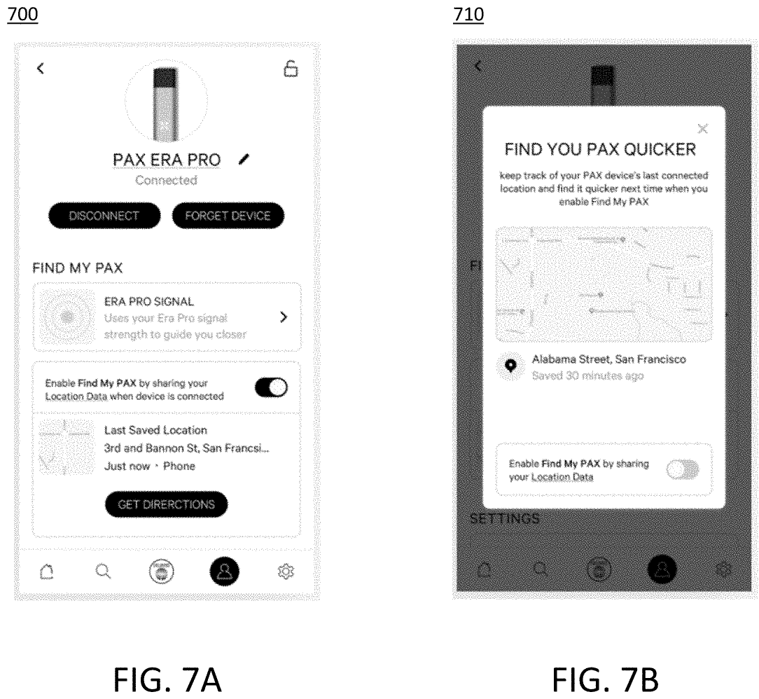

FIG. 7A-FIG. 7B are example user interfaces illustrating aspects of tracking the location of the vaporizer device 100, consistent with implementations of the current subject matter.

A user interface 700 in FIG. 7A illustrates a last saved location of the vaporizer device 100. The last saved location is depicted with an address and a map. Time and date data is also included. An option to share location data when the vaporizer device 100 is connected to the user device 305 is also provided. In some instances, a user may not wish to track the location of the vaporizer device 100 and may select that location data sharing not be activated.

A user interface 710 is provided in FIG. 7B and illustrates additional details related to tracking the vaporizer device 100. The user interface 710 provides details related to enabling the option of sharing location data to aid in tracking the location of the vaporizer device consistent with implementations of the current subject matter.

According to aspects of the current subject matter, the connection between the user device 305 and the vaporizer device 100 may enable the user device 305 to locate the vaporizer device 100. In particular, by using a received signal strength (RSS) and a transmit power value, the user device 305 may determine, based on known relationships between signal strength, transmit power, and distance, a distance between the user device 305 and the vaporizer device 100. According to aspects of the current subject matter, in an active connection state between the user device 305 and the vaporizer device 100, the user device 305 may query the vaporizer device 100 for signal information. In response, the vaporizer device 100 responds with a received signal strength indicator (RSSI) that indicates the signal strength (e.g., in dBm) of the signal transmitted by the user device 305 and received at the vaporizer device 100, and with a transmit power value that indicates the power level (e.g., in dBm) at which the vaporizer device 100 is transmitting. The wireless communication circuitry 142 may receive the signal from the user device 305, and the controller 128 of the vaporizer device 100 may determine the RSSI and may retrieve the transmit power value of the vaporizer device 100. The user device 305 uses the RSSI and the transmit power value to determine the distance between the user device 305 and the vaporizer device 100. For example, the user device 305 may utilize the Friis transmission equation or variations thereof to determine the distance. The user device 305 may then convey the distance data to a user of the user device 305 by updating a user interface with the distance data.

Consistent with implementations of the current subject matter, a user interface generated by an application running on the user device 305 may provide and/or include an option to locate the vaporizer device 100. Upon user selection of the option to locate the vaporizer device 100, the user device 305 may enter a “find vaporizer device” mode and instruct the vaporizer device 100 to enter the “find vaporizer device” mode, during which the output device 305 continuously and/or repeatedly (e.g., at a predetermined rate) queries the vaporizer device 100 for signal information from which the user device 305 determines the distance between it and the vaporizer device 100. With each distance determined, the user device 305 may update the user interface to reflect the updated distance. Consistent with implementations of the current subject matter, the distance may be indicated on the user interface as a distance from the vaporizer device 100. Accordingly, in a situation in which a user of the user device 305 moves around a room or other location while the user device 305 and the vaporizer device 100 are in the “find vaporizer device” mode, the user is presented with an updated user interface indicating if the user is moving closer to or farther from the vaporizer device 100 (e.g., as compared with a previous location).

Consistent with implementations of the current subject matter, a range of distances from the vaporizer device 100 may be defined, and each range may be associated with a particular visual indicator. When the user device 305 determines that the vaporizer device 100 is within a particular range, a corresponding visual indicator may be displayed on the user interface of the user device 305. For example, a plurality of concentric circles (or rings) may be provided in which each concentric circle corresponds to a given range of distances from the vaporizer device 100, which may be represented as a middle point of the plurality of concentric circle. When the user device 305 determines the distance from the vaporizer device 100, the concentric circle that corresponds to the determined distance may be illuminated or otherwise highlighted or emphasized so that the user is made aware of the distance between the user device 305 and the vaporizer device 100. Moreover, an indication may be made as to a more specific point within the range. For example, the concentric circle may be filled to represent a point within the concentric circle that is representative of the distance between the user device 305 and the vaporizer device 100. As the user moves his or her position, while holding the user device 305, the user interface is updated to reflect a new determined distance between the user device 305 and the vaporizer device 100, accordingly allowing the user to see if he or she is moving closer to or farther from the vaporizer device 100. For example, if the user is moving closer to the vaporizer device 100, as compared to a previous position, the user interface will illuminate or emphasize a concentric circle closer to the vaporizer device 100. If the user is moving farther from the vaporizer device 100, as compared to a previous position, the user interface will illuminate or emphasize a concentric circle farther from the vaporizer device 100.

Aspects of the current subject matter are not limited to the described concentric circle display. Rather, any other type of visual indicator may be used to convey to the user the distance between the user device 305 and the vaporizer device 100. For example, numerical values, textual descriptions, and other visual indicators may be used in accordance with the current subject matter. More than one type of visual indicator may be used, for example, a text description may be included with the concentric circle display. As one example, a number system may be defined in which a number is reflective of a distance between the user device 305 and the vaporizer device 100. As the user device 305 is moved, by the user, the user interface may display updated numbers to reflect the determined distance between the user device 305 and the vaporizer device 100. A textual representation may include, for example, an indicator if a current position is closer to or farther from a previous position.

Moreover, in the “find vaporizer device” mode, the vaporizer device 100 may generate one or more outputs to aid the user in locating the vaporizer device 100. For example, through user selection on the user interface, the user may initiate a command to control one or more forms of output of the vaporizer device 100. The output may include a visual output, haptic output, and/or audio output to aid the user in locating the vaporizer device 100. For example, the output may include animation and/or flashing of one or more light emitting diodes (LEDs) on the vaporizer device 100 (e.g., the LEDs 136), production of haptic feedback such as buzzing or vibrating by the haptics system 144, and/or emission of one or more audio tones. The user interface may include one or more options for selection of the desired type of output for the vaporizer device 100 to generate. While in the “find vaporizer device” mode, the user may switch between options, and more than one option may be selected.

In some implementations of the current subject matter, one or more parameters of the output may be predefined, user-determined, and/or user-adjustable. The one or more parameters may include the number of LEDs to flash, the length of time for flashing of the LEDs, the brightness of the LEDs, the color of the LEDs, the frequency of the haptic feedback, the length of time of the haptic feedback, the type of audio tone, the volume of the audio tone, the length of time for playing the audio tone, and/or any other configurable feature of the one or more forms of output. The output may continue to be generated by the vaporizer device 100 until the vaporizer device 100 receives a command from the user device 305 to stop. The command from the user device 305 may be initiated in response to user selection on the user interface.

According to aspects of the current subject matter, a timeout period is defined for the “find vaporizer device” mode. The timeout period defines a length of time for the selected outputs to be generated by the vaporizer device 100. For example, when the user selects haptic feedback, the haptic feedback will be outputted for a length of time that equals the timeout period unless the timeout period is otherwise interrupted by another command or instruction. When the timeout period expires, the vaporizer device 100 may send status information to the user device 305. The user device 305, in response to the status information, may update the user interface to indicate the end of the timeout period and/or the end of the “find vaporizer device” mode. In some implementations, once the timeout period ends, the user may restart or reinitiate the timeout period by selecting an output option.

The user interface may include a selection option for the user to indicate when the user has located the vaporizer device 100. For example, once the user finds the vaporizer device 100, the user may select an option that indicates the vaporizer device 100 is located. The user device 305 may send an instruction to the vaporizer device 100 to stop the “find vaporizer device” mode, resulting in the vaporizer device 100 terminating the output (e.g., the haptic feedback and/or the LED flashing).

In some implementations, the vaporizer device 100 may detect one or more warning conditions associated with the vaporizer device 100. The warning conditions may include, for example, a low battery level (e.g., when the battery is at or below a predefined battery threshold level) and/or a temperature warning (e.g., when the heater 166 reaches a predefined temperature threshold level). Upon detection of one or more warning conditions, the vaporizer device 100 may stop the “find vaporizer device” mode, resulting in the vaporizer device 100 terminating the output. The vaporizer device 100 sends status information indicative of the warning condition to the user device 305. The vaporizer device 100 may enter a locked state during which activation of the heater will not occur (e.g., the heater circuitry 130 will not respond to a puff on the mouthpiece of the vaporizer device 100).

The locked state may also be entered in response to user selection via the user interface. The user, upon using the “find vaporizer device” mode, may wish to lock the vaporizer device 100 so that it cannot be used until located by the user. Upon selection of an option to lock the device, the user device 305 sends an instruction to the vaporizer device 100 to enter the locked state during which activation of the heater will not occur (e.g., the heater circuitry 130 will not respond to a puff on the mouthpiece of the vaporizer device 100). The user device 305 may also provide on the user interface an indication that the vaporizer device 100 is locked. The indication on the user interface of the user device 305 may be in response to a confirmation signal, confirming the locked state, sent by the vaporizer device 100 to the user device 305.

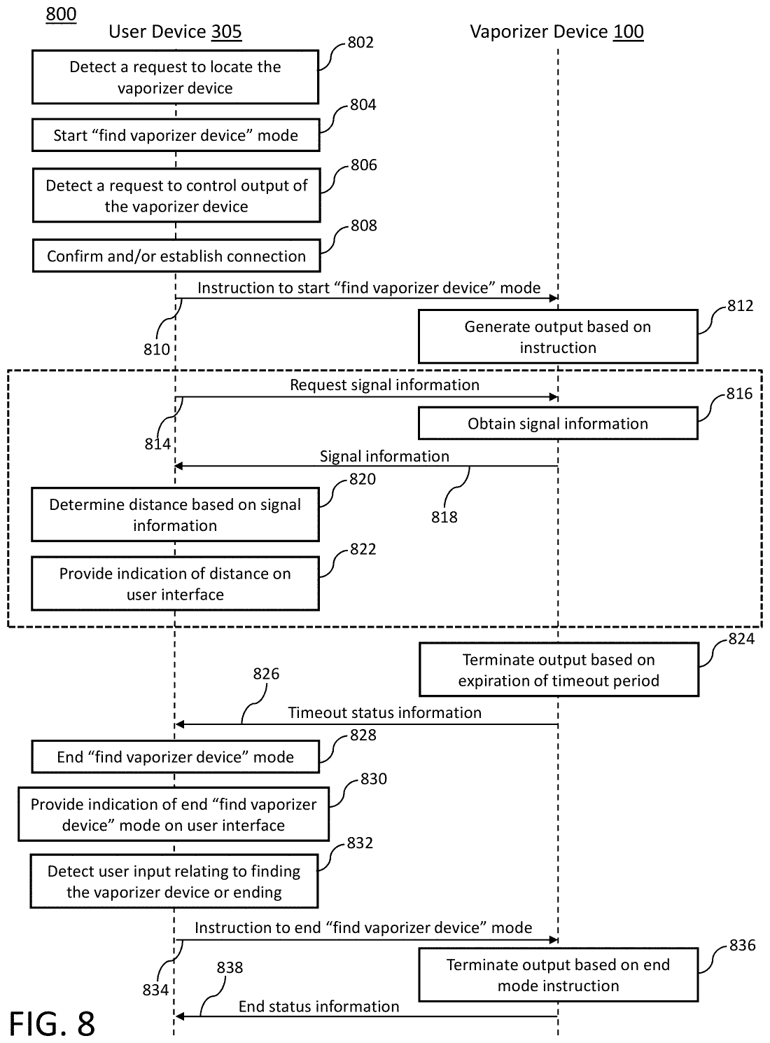

FIG. 8 depicts a swim lane diagram 800 illustrating aspects related to locating the vaporizer device 100 consistent with implementations of the current subject matter. In particular, the swim lane diagram 800 depicts operations of and communication between the user device 305 and the vaporizer device 100. The operations in the swim lane diagram 800 may follow the operations for establishing a connection between the user device 305 and the vaporizer device 100, as described with reference to the swim lane diagram 500 of FIG. 5.

At 802, the user device 305 detects a request to locate the vaporizer device 100. For example, a user may initiate the request through a user interface generated by an application running on the user device 305. At 804, in response to detecting the request to locate the vaporizer device 100, the user device 305 enters the “find vaporizer device” mode.

At 806, the user device 305 detects a request to control output of the vaporizer device 100. For example, the user device 305 detects a user selection of haptic feedback (e.g., buzzing) or LED animation (e.g., turn on or flash LEDs).

At 808, prior to the user device 305 initiating communication and data exchange with the vaporizer device 100 in accordance with the “find vaporizer device” mode features, the user device 305 confirms and/or establishes connection with the vaporizer device 100. For example, the user device 305 may determine a connection status with the vaporizer device 100. For example, the user device 305 may determine if an active connection state or an inactive connection state exists between the user device 305 and the vaporizer device 100. According to some implementations of the current subject matter, the user device 305 may check the connection state to determine if a connection establishment needs to be initiated to locate the vaporizer device 100. Upon a determination that the vaporizer device 100 and the user device 305 are not actively connected, the user device 305 may send an initiate connection message. The initiate connection message may include identifying data that the vaporizer device 100 recognizes to determine that the initiate connection message is a valid message from a device to which the vaporizer device 100 has been previously paired. In response to receiving the initiate connection message, the vaporizer device 100 may determine to connect with the user device 305. In some implementations, the vaporizer device 100 may determinate that the initiate connection message is a valid message from a device to which the vaporizer device has been previously paired. Upon determining to connect with the user device 305, the vaporizer device 100 transmits to the user device 305 a connection established message. After reconnecting with the vaporizer device 100, the user device's application may allow the user device 305 (or its associated user) to configure, control, and/or monitor the vaporizer device 100, consistent with implementations of the current subject matter.

At 810, upon confirming or establishing connection with the vaporizer device 100, the user device 305 sends to the vaporizer device 100 an instruction to start “find vaporizer device” mode. The instruction may define output parameters representative of the type of output for the vaporizer device 100 to generate. For example, the output parameters may include start haptics and LED animations, start LED animations only, start haptics only, start with no output. The instruction may also include data defining the timeout period. For example, the instruction may include the timeout period value, which is the length of time that the vaporizer device 100 will generate the output defined by the output parameters. In some instances, a timeout period may not be defined, and the vaporizer device 100 may assign a default value as the timeout period.

At 812, in response to the instruction to start “find vaporizer device” mode with the defined output parameters, the vaporizer device 100 generates the corresponding output and begins a timer to monitor the timeout period.

Consistent with implementations of the current subject matter, a continuous and/or repeated process occurs in which the user device 305 determines distance between the user device 305 and the vaporizer device 100 and displays an indication of the distance on the user interface. The continuous and/or repeated process may occur at a defined frequency.

In particular, at 814, the user device 305 requests signal information from the vaporizer device 100. At 816, in response to the signal information request, the vaporizer device 100 obtains a received signal strength indicator (RSSI) that indicates the signal strength (e.g., in dBm) of the signal transmitted by the user device 305 and received at the vaporizer device 100, and a transmit power value that indicates the power level (e.g., in dBm) at which the vaporizer device 100 is transmitting. At 818, the vaporizer device 100 transmits to the user device 305 the signal information.

At 820, the user device 305 uses the RSSI and the transmit power value to determine the distance between the user device 305 and the vaporizer device 100. For example, the user device 305 may utilize the Friis transmission equation, or variations thereof or other known equations that take into account a known relationship between signal strength and/or transmit power and distance, to determine the distance. In particular, by using the RSSI and the transmit power value, the user device 305 may determine, based on known relationships between signal strength, transmit power, and distance, the distance between the user device 305 and the vaporizer device 100.

At 822, the user device 305 provides an indication of the distance to the user of the user device 305 by updating the user interface with the distance data. For example, the user interface may display a plurality of concentric rings or circles with a central point representative of a position of the vaporizer device 100. As the user, holding the user device 305, moves, a concentric circle representative of the location of the user device 305 with respect to the vaporizer device 100 is illuminated or otherwise highlighted or emphasized so that the user is made aware of the distance between the user device 305 and the vaporizer device 100. In some implementations, a numeric and/or textual representation of the distance between the user device 305 and the vaporizer device 100 may be provided. For example, a number system may be defined in which a number is reflective of a distance between the user device 305 and the vaporizer device 100. As the user device 305 is moved, by the user, the user interface may display updated numbers to reflect the determined distance. A textual representation may include, for example, an indicator if a current position is closer to or farther from a previous position.

The process of requesting signal information from the vaporizer device 100 and using the information signal to determine distance and update the indication of distance on the user interface (as in 814, 816, 818, 820, and 822) may be an iterative or repeatable process that occurs until the user device 305 detects a stop request initiated via user selection on the user interface or status information from the vaporizer device 100, the status information including a timeout expiration indicator or a warning condition indicator.

At 824, the vaporizer device 100, upon determination that the timeout period has expired, terminates or stops the output (e.g., the haptics and/or the LED animation). At 826, the vaporizer device 100 sends to the user device 305 a status information signal including a timeout expiration indicator.

At 828, in response to the timeout status information, the user device 305 ends the “find vaporizer device” mode, and at 830 provides an indication on the user interface indicative of the “find vaporizer device” mode ending.

Following 828, the user may decide to restart the “find vaporizer device” mode, in which case the process would begin again at 802.

At 832, the user device 305 may detect user input relating to finding the vaporizer device or ending the “find vaporizer device” mode. This may occur after the timeout period expires or before expiration of the timeout period (e.g., before 824).

At 834, in response to the detection of user input at 832, the user device 305 sends an instruction to the vaporizer device 100 to end the “find vaporizer device” mode. At 836, in response, the vaporizer device 100 terminates or stops the output (e.g., the haptics and/or the LED animation). At 838, the vaporizer device 100 sends to the user device 305 a status information signal including an end “vaporizer device mode” indicator.

Consistent with implementations of the current subject matter, the user may change the output being generated by the vaporizer device 100 during the “find vaporizer device” mode. For example, the user may decide to switch between output options or may select another output option in addition to a current output option. The user may select the desired output option on the user interface, the selection of which is detected by the user device 305. In response to the detection, the user device 305 may send to the vaporizer device 100 an instruction to change the output. The instruction may define the new output parameters representative of the type of new output for the vaporizer device 100 to generate. For example, the new output parameters may include change to haptics and LED animations, change to LED animations only, change to haptics only, change to no output. In some implementations, the timeout period may restart when the output options are changed. The instruction may include an indicator of if the timeout period should continue or restart.

In some implementations, the RSSI and/or the transmit power value and the preceding and subsequent messaging are sent through the wireless communication circuitry 142 in accordance with a standard such as Bluetooth or Bluetooth Low Energy (BLE). In some implementations, the cartridge 150 and/or the vaporizer body 110 of the vaporizer device 100 may include a radio frequency identification (RFID) tag that enables tracking of the cartridge 150 and/or the vaporizer body 110. For example, the user device 305 may obtain signal strength from the RFID tag.

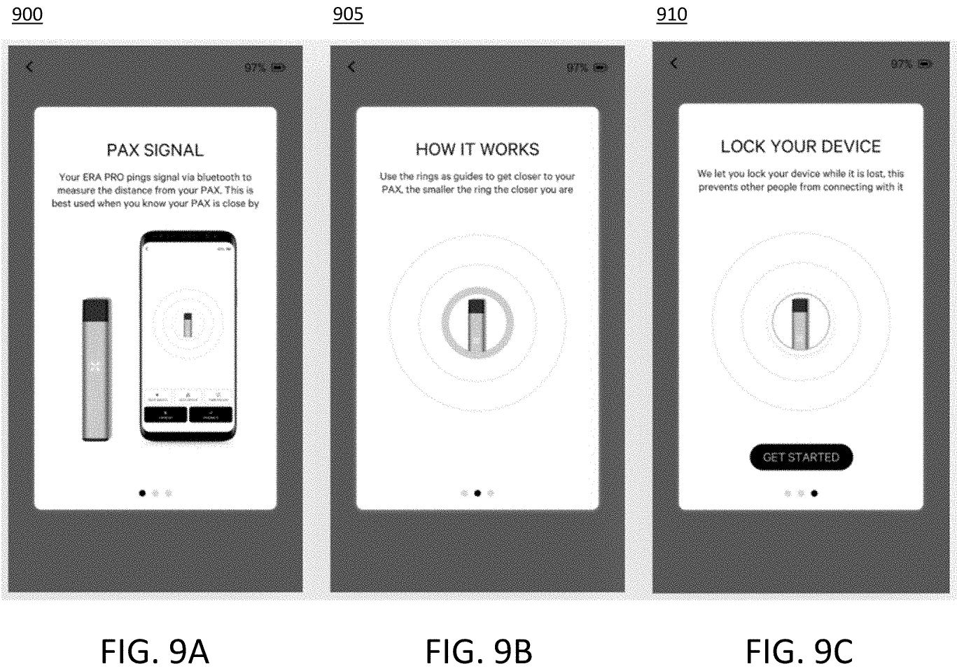

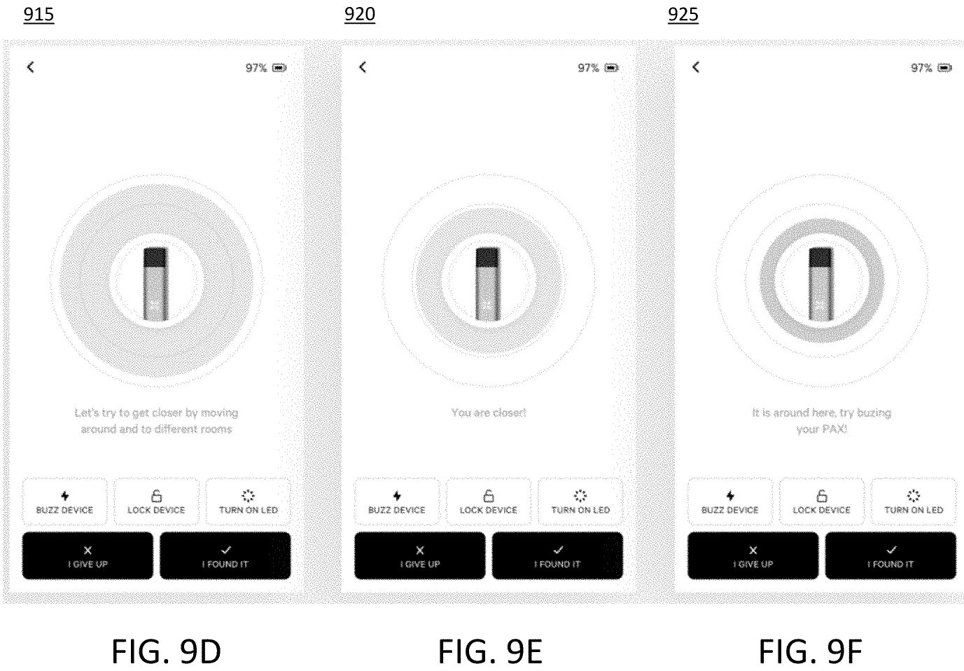

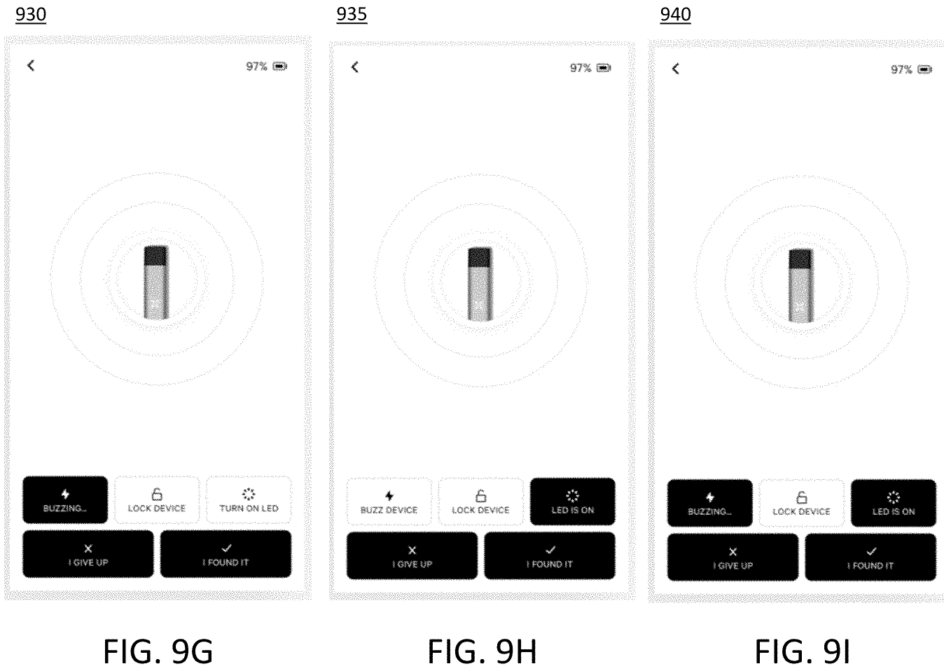

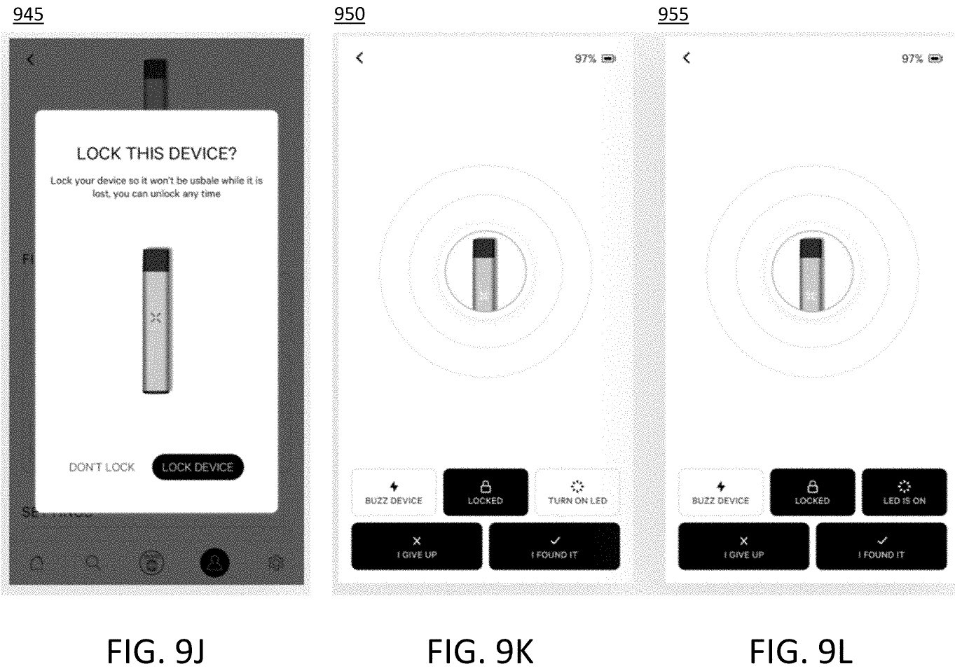

FIG. 9A-FIG. 9L are example user interfaces illustrating aspects of locating the vaporizer device 100, consistent with implementations of the current subject matter.

A user interface 900 in FIG. 9A, a user interface 905 in FIG. 9B, and a user interface 910 in FIG. 9C provide to the user information regarding vaporizer device location features provided by the interaction of the user device 305 and the vaporizer device 100 consistent with implementations of the current subject matter. The user interface 900 in FIG. 9A provides an introduction to the “find vaporizer device” features consistent with implementations of the current subject matter. In particular, the user interface 900 provides details that indicate a wireless connection (e.g., a Bluetooth connection) between the user device 305 and the vaporizer device 100 may be used to assist in locating the vaporizer device 100. Consistent with implementations of the current subject matter, the “find vaporizer device” features are indicated to be effective if the user device 305 and the vaporizer device 100 are in close proximity to one another.

The user interface 905 in FIG. 9B displays an example of a display that allows the user to locate the vaporizer device 100 using the “find vaporizer device” features consistent with implementations of the current subject matter. In particular, an image of a vaporizer device is provided at a middle or central point with respect to a plurality of concentric circles surrounding the image of the vaporizer device. According to aspects of the current subject matter, each concentric circle corresponds to a given range of distances from the vaporizer device 100, with the innermost concentric circle representative of a closest range of distances to the vaporizer device 100 and the outermost concentric circle representative of a farthest distance to the vaporizer device 100. The concentric circle corresponding to the distance between the user device 305 and the vaporizer device 100 may be illuminated or otherwise highlighted or emphasized to depict the current distance between the user device 305 and the vaporizer device 100. As the user, holding the user device 305, moves position, the concentric circle display on the user interface 905 will be updated to reflect a new distance between the user device 305 and the vaporizer device 100. Moreover, an indication may be made as to a more specific point within the range provided by the plurality of concentric circles. For example, the concentric circle may be filled to represent a point within the concentric circle that is representative of the distance between the user device 305 and the vaporizer device 100. As the user moves his or her position, while holding the user device 305, the user interface 905 is updated to reflect a new determined distance between the user device 305 and the vaporizer device 100, accordingly allowing the user to see if he or she is moving closer to or farther from the vaporizer device 100. For example, if the user is moving closer to the vaporizer device 100, as compared to a previous position, the user interface will illuminate or emphasize a concentric circle closer to the vaporizer device depicted in the user interface 905. If the user is moving farther from the vaporizer device 100, as compared to a previous position, the user interface will illuminate or emphasize a concentric circle farther from the vaporizer device 100 depicted in the user interface 905. Consistent with implementations of the current subject matter, the illumination or emphasis of the concentric circles may increase from the outermost concentric circle to the innermost concentric circle. For example, the innermost concentric circle may illuminate in a brighter shade than that of the outermost concentric circle.

The user interface 910 in FIG. 9C indicates that the “find vaporizer device” features allow for the user to select via the user interface an option to lock the vaporizer device 100 so that the vaporizer device 100 cannot be used (e.g., does not respond to a user puff or other activation) until otherwise indicated.

A user interface 915 in FIG. 9D, a user interface 920 in FIG. 9E, and a user interface 925 in FIG. 9F illustrate features relating to the indication provided to the user to depict the location of the vaporizer device 100 with respect to the user device 305. The plurality of concentric circles, representing the distance between the vaporizer device 100 and the user device 305 are provided as a visual indicator to the user. Descriptive text may also be provided to aid in the user locating the vaporizer device 100.

As shown in FIG. 9D, an initial distance is reflected on the user interface 915 and indicates that the vaporizer device 100 is near the outer limits of a detectable range from the user device 305 (e.g., the outermost concentric circle is filled almost to its outer limits). Textual description is provided to notify the user to move around to different positions. As shown in FIG. 9E, the user device 305 is now closer to the vaporizer device 100 from the previous position as a concentric circle closer to the vaporizer device indicator is now filled, and a textual description indicating that the user is closer is displayed. The user interface 925 in FIG. 9F indicates that the user device 305 is now even closer to the vaporizer device 100, as depicted by the innermost circle being highlighted in a brighter shade. The user interface 925 also provides a textual description to alert the user that the vaporizer device 100 is nearby and that a type of output (e.g., “buzzing” or haptic output) may help the user locate the vaporizer device.

Aspects of the current subject matter are not limited to the described concentric circle display. Rather, any other type of visual indicator may be used to convey to the user the distance between the user device 305 and the vaporizer device 100. For example, numerical values, textual descriptions, and other visual indicators may be used in accordance with the current subject matter. More than one type of visual indicator may be used, for example, a text description may be included with the concentric circle display. As one example, a number system may be defined in which a number is reflective of a distance between the user device 305 and the vaporizer device 100. As the user device 305 is moved, by the user, the user interface may display updated numbers to reflect the determined distance between the user device 305 and the vaporizer device 100. A textual representation may include, for example, an indicator if a current position is closer to or farther from a previous position. As another example utilizing a concentric circle display, an indicator or icon (e.g., a flashing or sold circle or an “x” or other symbol) may be placed on a concentric circle that corresponds to the distance between the user device 305 and the vaporizer device 100.

A user interface 930 in FIG. 9G, a user interface 935 in FIG. 9H, and a user interface 940 in FIG. 9I indicate user selection features for controlling output of the vaporizer device 100. As illustrated, different forms of output are provided in the form of selectable options or buttons and may include haptic feedback (e.g., “buzzing”) and illumination of LEDs (e.g., “turn on LED”). As shown, more than one output option may be selected at a time. In some implementations, rather than selectable buttons a drop-down list may be selected and provided to include the options for haptic feedback and illumination of the LEDs, as well as other options described herein.

The user interface 930 in FIG. 9G, the user interface 935 in FIG. 9H, and the user interface 940 in FIG. 9I also include selectable options or buttons to “lock device,” selection of which results in the user device 305 communicating a lock command to the vaporizer device 100, the lock command indicating to the vaporizer device 100 to not respond to user controlled actions to use the vaporizer device 100. “I give up” and “I found it” selectable options or buttons are also provided, selection of which results in the user device 305 ending the “find vaporizer device” features consistent with implementations of the current subject matter as described herein.

A user interface 945 in FIG. 9J, a user interface 950 in FIG. 9K, and a user interface 955 in FIG. 9L indicate user selection features associated with locking the vaporizer device 100. As shown in the user interface 945 of FIG. 9J, upon selection of the “lock device” option (e.g., see FIG. 9G, FIG. 9H, and FIG. 9I), a confirmation message is provided to confirm the user selection of locking the device. The confirmation message includes the options for the user to select “don't lock” or “lock device.” As described herein, consistent with implementations of the current subject matter, locking the device results in the user device 305 issuing a lock command to the vaporizer device 100 to not respond to user activation (e.g., user puffing) of the vaporizer device 100. The user interface 950 in FIG. 9K illustrates that while locked, an additional indicator (e.g., a red circle and the highlighting of the “locked” selection option) may be provided to reflect the locked state. As illustrated in the user interface 955 in FIG. 9L, output of the vaporizer device 100 may be selected (e.g., selection of the “LED is on” option) while the vaporizer device 100 is locked.

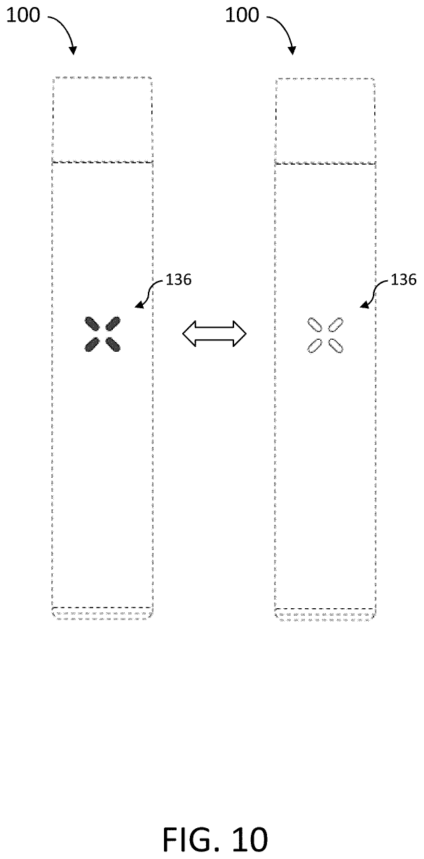

With reference to FIG. 10, an example of vaporizer device 100 outputs consistent with implementations of the current subject matter are illustrated. For example, illustrated is an example in which the LEDs 136 of the vaporizer device 100 flash from off (left-hand side) to on (right-hand side). As described herein, various other forms of LED animation may be implemented consistent with implementations of the current subject matter.

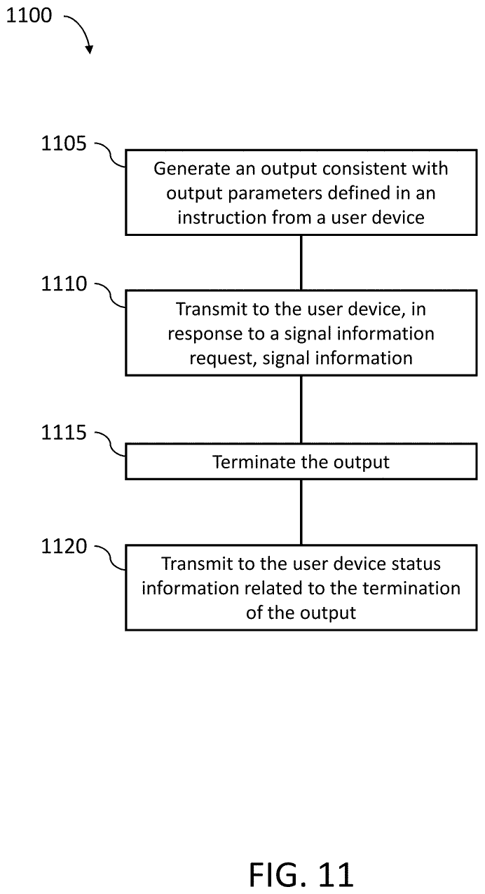

With reference to FIG. 11, a chart 1100 illustrates features of a method, which may optionally include some or all of the following. With reference to FIG. 1A-FIG. 4, the following may be implemented by the vaporizer device 100 (or the vaporizer device 200).

At 1105, the vaporizer device 100 generates an output consistent with output parameters defined in an instruction received from the user device 305. For example, the user device 305, upon detecting a user request to locate the vaporizer device 100 and initiating a “find vaporizer device” mode, sends to the vaporizer device 100 an instruction (and the vaporizer device 100 receives the instruction) to start “find vaporizer device” mode. The instruction may define output parameters representative of the type of output for the vaporizer device 100 to generate. The output parameters may include at least one of a haptic feedback and an animation of the LEDs 136, such as start haptics and LED animations, start LED animations only, start haptics only, start with no output. The instruction may also include data defining a timeout period. The instruction may include a timeout period value, which is the length of time for which the vaporizer device 100 is instructed to generate the output defined by the output parameters. According to aspects of the current subject matter, prior to generating the output defined in the instruction from the user device 305, the vaporizer device 100 may respond to a connection request from the user device 305 by determining to connect with the user device 305. In some implementations, the determination to connect with the user device 305 may be based on a previous establishment with the user device 305.

In some implementations, the vaporizer device 100 generates a first output consistent with first output parameters defined in a first instruction received from the user device 305. For example, the vaporizer device 100 may generate a first output in response to receiving a first instruction from the vaporizer device 100. The first output parameters may include start haptics and LED animations, start LED animations only, start haptics only, and/or start with no output. The first instruction may also include data defining the timeout period. For example, the first instruction may include the timeout period value, which is the length of time that the vaporizer device 100 will generate the first output defined by the first output parameters. In some instances, a timeout period may not be defined, and the vaporizer device 100 may assign a default value as the timeout period.

In some implementations, the vaporizer device 100 generates a second output consistent with second output parameters defined in a second instruction received from the user device 305. For example, the vaporizer device 100 may generate a second output in response to receiving a second instruction from the vaporizer device 100. The second output parameters may include haptics and LED animations, LED animations only, haptics only, and/or the like. The second instruction may also include data defining the stop or end period. For example, the second instruction may include stop command value, which is the length of time that the vaporizer device 100 will generate the second output defined by the second output parameters. In some instances, a stop or end period may not be defined, and the vaporizer device 100 may assign a default value as the stop or end period.

At 1110, the vaporizer device 100 transmits, in response to a signal information request from the user device 305, signal information to the user device 305. Consistent with implementations of the current subject matter, for the user device 305 to determine a distance between the user device 305 and the vaporizer device 100, the user device 305 queries the vaporizer device 100 for signal information. In response to the signal information request, the vaporizer device 100 obtains a received signal strength indicator (RSSI) that indicates the signal strength (e.g., in dBm) of the signal transmitted by the user device 305 and received at the vaporizer device 100, and a transmit power value that indicates the power level (e.g., in dBm) at which the vaporizer device 100 is transmitting. The vaporizer device 100 then transmits to the user device 305 the signal information.

Consistent with implementations of the current subject matter, the user device 305 repeatedly (e.g., at a defined rate) determines the distance between the user device 305 and the vaporizer device 100 in order to display an indication of the distance on the user interface of the user device 305. Thus, the user device 305 may provide a series of signal information requests to the vaporizer device 100. In response to each signal information request of the series, the vaporizer device obtains and transmits to the user device 305 the RSSI and the power transmit value, thus allowing the user device 305 to determine a new distance and display an indication of the new distance on the user interface. In other words, the signal information transmitted by the vaporizer device 100 may include a series of received signal strength indicators and/or a series of power transmit values. In some implementations, the vaporizer device 100 transmits, to the user device 305 and in response to a first signal information request from the user device 305, a received signal strength indicator and a power transmit value.

At 1115, the vaporizer device 100 terminates the output that was being generated in response to the instruction from the user device 305. Consistent with implementations of the current subject matter, the termination of the output may be in response to an expiration of the timeout period, a receipt from the user device 305 of a second instruction including a stop command, or a determination of a warning condition of the vaporizer device 100. In some implementations, the vaporizer device 100 terminates a first output in response to a determination of expiration of a timeout period. The timeout period may be defined in a first instruction. In some implementations, the vaporizer device 100 terminates a second output in response to a third instruction received from the user device 305. The third instruction may include a stop command.

At 1120, the vaporizer device 100 transmits to the user device 305 status information related to the termination of the output at 1115. Consistent with implementations of the current subject matter, the status information provided by the vaporizer device 100 is meant to inform the user device 305 of the output being terminated and/or to confirm that the output is terminated in response to an instruction from the user device. Consistent with implementations of the current subject matter, the status information may include an indicator indicative of the timeout period expiration, the stop command, or the warning condition. In the event of the warning condition, which may include a low battery level or a temperature warning, the vaporizer device 100 may disconnect the connection with the user device 305. For example, if the battery level is low, to conserve power the vaporizer device 100 may stop the communication and data exchange with the user device 305. In some implementations, the vaporizer device 100 transmit a first status information (e.g., a timeout expiration indicator) to the user device 305 in response to the termination of a first output. In some implementations, the vaporizer device 100 transmits a second status information (e.g., a stop command indicator) in response to terminating a second status information.

According to aspects of the current subject matter, the vaporizer device 100 may receive a lock command from the user device 305. Upon receipt of the lock command, the vaporizer device 100 may enter a locked state during which activation of the heater will not occur (e.g., the heater circuitry 130 will not respond to a puff on the mouthpiece of the vaporizer device 100).

While the vaporizer device 100 is generating the output in accordance with the instruction from the user device 305, the user may wish to change the output and select a new output option via user selection on the user interface of the user device 305. For example, the user may select the desired output option on the user interface, the selection of which is detected by the user device 305. In response to the detection, the user device 305 may send to the vaporizer device 100 an instruction to change the output. The instruction may define the new output parameters representative of the type of new output for the vaporizer device 100 to generate. In response to the instruction, the vaporizer device 100 generates a second output consistent with second output parameters defined in the instruction from the user device 305. The vaporizer device 100 terminates, consistent with implementations of the current subject matter, the second output in response to an expiration of a second timeout period, receipt from the user device 305 of a stop command, or a determination of a warning condition of the vaporizer device 100.

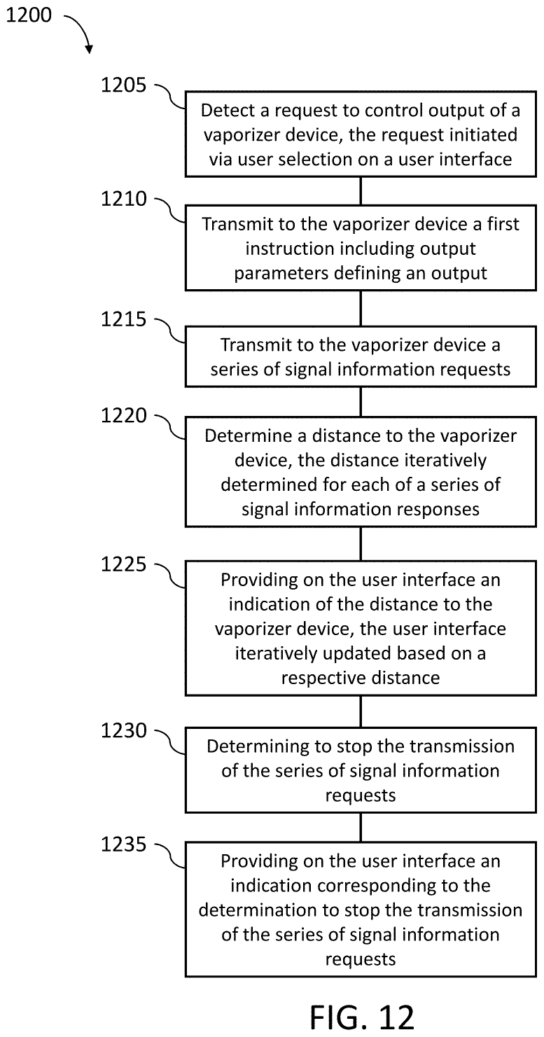

With reference to FIG. 12, a chart 1200 illustrates features of a method, which may optionally include some or all of the following. The following may be implemented by an application running on the user device 305 (e.g., an apparatus).

At 1205, the user device 305 detects a request to control output of the vaporizer device 100 that is associated with the user device 305. Consistent with implementations of the current subject matter, the request is initiated via user selection on the user interface provided by the user device 305. For example, the user interface may provide one or more options of output that may be selected by the user for the vaporizer device 100 to generate to aid the user in locating the vaporizer device 100. For example, the user device 305 detects a user selection of haptic feedback (e.g., buzzing) or LED animation (e.g., turn on or flash LEDs).

At 1210, the user device 305 transmits, to the vaporizer device 100, a first instruction including output parameters that define an output for the vaporizer device 100 to generate. The user device 305, upon detecting the request to control output, generates a first instruction that corresponds to the detected request and that defines output parameters representative of the type of output for the vaporizer device 100 to generate. For example, the output parameters may include start haptics and LED animations, start LED animations only, start haptics only, start with no output. The first instruction may also include data defining the timeout period. For example, the first instruction may include the timeout period value, which is the length of time that the vaporizer device 100 will generate the output defined by the output parameters. In some instances, a timeout period may not be defined, and the vaporizer device 100 may assign a default value as the timeout period.

At 1215, the user device 305 transmits to the vaporizer device 100 a series (e.g., one, two, three, four, five, or more) of signal information requests. The series of signal information requests may be transmitted to the vaporizer device 100 in response to transmission of the first instruction to the vaporizer device and/or in response to detecting that the vaporizer device 100 is generating the first output. Consistent with implementations of the current subject matter, for the user device 305 to determine a distance between the user device 305 and the vaporizer device 100, the user device 305 queries the vaporizer device 100 for signal information that the user device 305 may use to determine the distance between the user device 305 and the vaporizer device 100.

At 1220, the user device 305 determines a distance to the vaporizer device 100. Consistent with implementations of the current subject matter, the user device 305 repeatedly (e.g., at a defined rate) determines the distance between the user device 305 and the vaporizer device 100. Thus, the user device 305 may provide the series of signal information requests to the vaporizer device 100. In response to each signal information request of the series, the vaporizer device 100 obtains and transmits to the user device 305 the RSSI and the power transmit value, thus allowing the user device 305 to determine a new distance. In particular, the distance is iteratively determined for each of a series of signal information responses received form the vaporizer device 100 such that each of the series of signal information responses corresponds to a respective distance.

At 1225, an indication of the distance to the vaporizer device 100 is provided on the user interface. The user interface is iteratively updated based on the respective distance associated with each of the series of signal information responses received by the user device 305. According to some implementations, the indication of the distance to the vaporizer device 100 may be represented as a circle among a plurality of concentric circles. The circles may be iteratively updated on the user interface.

At 1230, the user device 305 makes a determination to stop the transmission of the series of signal information requests. The determination is in response to receiving from the vaporizer device 100 status information including a timeout expiration indicator, receiving from the vaporizer device 100 status information including a warning condition indicator, or detecting a stop request initiated via user selection on the user interface.

At 1235, an indication corresponding to the timeout expiration indicator, the warning condition indicator, or the stop request is provided on the user interface. For example, the user device 305 may generate and display an indicator to reflect that the user device 305 is no longer locating the vaporizer device 100 by finding the distance between the user device 305 and the vaporizer device 100 (e.g., the “find vaporizer device” mode is ended). The indicator may specify the reason that the “find vaporizer device” mode is ended.

The disclosed aspects provide location services that enable tracking location of a vaporizer device and locating a vaporizer device through use of an application running on a user device (e.g., a mobile device) with an established connection or pairing to the vaporizer device, thus conveniently allowing a user to track and locate the vaporizer device. The disclosed aspects also provide for locking the vaporizer device when the vaporizer device is missing, thereby increasing safety.

In some examples, the vaporizable material may include a viscous liquid such as, for example a cannabis oil. In some variations, the cannabis oil comprises between 0.3% and 100% cannabis oil extract. The viscous oil may include a carrier for improving vapor formation, such as, for example, propylene glycol, glycerol, medium chain triglycerides (MCT) including lauric acid, capric acid, caprylic acid, caproic acid, etc., at between 0.01% and 25% (e.g., between 0.1% and 22%, between 1% and 20%, between 1% and 15%, and/or the like). In some variations the vapor-forming carrier is 1,3-Propanediol. A cannabis oil may include a cannabinoid or cannabinoids (natural and/or synthetic), and/or a terpene or terpenes derived from organic materials such as for example fruits and flowers. For example, any of the vaporizable materials described herein may include one or more (e.g., a mixture of) cannabinoid including one or more of: CBG (Cannabigerol), CBC (Cannabichromene), CBL (Cannabicyclol), CBV (Cannabivarin), THCV (Tetrahydrocannabivarin), CBDV (Cannabidivarin), CBCV (Cannabichromevarin), CBGV (Cannabigerovarin), CBGM (Cannabigerol Monomethyl Ether), Tetrahydrocannabinol, Cannabidiol (CBD), Cannabinol (CBN), Tetrahydrocannabinolic Acid (THCA), Cannabidioloc Acid (CBDA), Tetrahydrocannabivarinic Acid (THCVA), one or more Endocannabinoids (e.g., anandamide, 2-Arachidonoylglycerol, 2-Arachidonyl glyceryl ether, N-Arachidonoyl dopamine, Virodhamine, Lysophosphatidylinositol), and/or a synthetic cannabinoids such as, for example, one or more of: JWH-018, JWH-073, CP-55940, Dimethylheptylpyran, HU-210, HU-331, SR144528, WIN 55,212-2, JWH-133, Levonantradol (Nantrodolum), and AM-2201. The oil vaporization material may include one or more terpene, such as, for example, Hemiterpenes, Monoterpenes (e.g., geraniol, terpineol, limonene, myrcene, linalool, pinene, Iridoids), Sesquiterpenes (e.g., humulene, farnesenes, farnesol), Diterpenes (e.g., cafestol, kahweol, cembrene and taxadiene), Sesterterpenes, (e.g., geranylfarnesol), Triterpenes (e.g., squalene), Sesquarterpenes (e.g, ferrugicadiol and tetraprenylcurcumene), Tetraterpenes (lycopene, gamma-carotene, alpha- and beta-carotenes), Polyterpenes, and Norisoprenoids. For example, an oil vaporization material as described herein may include between 0.3-100% cannabinoids (e.g., 0.5-98%, 10-95%, 20-92%, 30-90%, 40-80%, 50-75%, 60-80%, etc.), 0-40% terpenes (e.g., 1-30%, 10-30%, 10-20%, etc.), and 0-25% carrier (e.g., medium chain triglycerides (MCT)).

In any of the oil vaporizable materials described herein (including in particular, the cannabinoid-based vaporizable materials), the viscosity may be within a predetermined range. At room temperature of about 23° C., the range may be between about 30 cP (centipoise) and about 200 kcP (kilocentipoise). Alternatively, the range may be between about 30 cP and about 115 kcP. Alternatively, the range may be between about 40 cP and about 113 kcP. Alternatively, the range may be between about 50 cP and about 100 kcP. Alternatively, the range may be between about 75 cP and about 75 kcP. Alternatively, the range may be between about 100 cP and about 50 kcP. Alternatively, the range may be between about 125 cP and about 25 kcP. Outside of these ranges, the vaporizable material may fail in some instances to wick appropriately to form a vapor as described herein. In particular, it is typically desired that the oil may be made sufficiently thin to both permit wicking at a rate that is useful with the apparatuses described herein, while also limiting leaking. For example, viscosities below that of about 30 cP at room temperature might result in problems with leaking, and in some instances viscosities below that of about 100 cP at room temperature might result in problems with leaking.

Although the disclosure, including the figures, described herein may described and/or exemplify these different variations separately, it should be understood that all or some, or components of them, may be combined.

Although various illustrative embodiments are described above, any of a number of changes may be made to various embodiments. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the claims.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. References to a structure or feature that is disposed “adjacent” another feature may have portions that overlap or underlie the adjacent feature.

Terminology used herein is for the purpose of describing particular embodiments only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as, for example, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” “or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, are possible.

In the descriptions above and in the claims, phrases such as, for example, “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A vaporizer device, comprising:
at least one data processor; and
at least one memory storing instructions which, when executed by the at least one data processor, cause operations comprising:
generating, in response to an instruction from a user device, an output;
transmitting, to the user device and in response to a series of signal information requests from the user device, a series of received signal strength indicators and/or power transmit values;
terminating the output, wherein the terminating of the output is responsive to one of an expiration of a timeout period, a receipt from the user device of a second instruction including a stop command, or a determination of a warning condition of the vaporizer device; and
transmitting, to the user device and in response to the terminating of the output, status information, wherein the status information comprises an indicator indicative of the timeout period expiration, the stop command, or the warning condition.

2. The vaporizer device of claim 1, wherein the output comprises at least one of a haptic feedback and an animation of one or more light emitting diodes.

3. The vaporizer device of claim 1, wherein the instruction defines the timeout period.

4. The vaporizer device of claim 1, wherein each of the series of received signal strength indicators and/or power transmit values is responsive to a respective one of the series of signal information requests.

5. The vaporizer device of claim 1, wherein the warning condition comprises one or more of a low battery level and a temperature warning.

6. The vaporizer device of claim 1, wherein the operations further comprise:
responsive to the determination of the warning condition, disconnecting a connection with the user device.

7. The vaporizer device of claim 1, wherein the operations further comprise:
entering, in response to a lock command from the user device, a locked state during which heater circuitry of the vaporizer device does not respond to a user activation of the vaporizer device.

8. The vaporizer device of claim 1, wherein the operations further comprise:
responsive to a connection request from the user device, determining to connect with the user device, the determination based on a previous establishment with the user device.

9. The vaporizer device of claim 1, wherein the operations further comprise:
generating, in response to a second instruction from the user device, a second output.

10. The vaporizer device of claim 9, wherein the operations further comprise:
terminating the second output, wherein the terminating of the second output is responsive to one of the expiration of a second timeout period, receipt from the user device of a third instruction including a second stop command, or a determination of a second warning condition of the vaporizer device; and
transmitting, to the user device and in response to terminating the second output, a second status information, wherein the second status information comprises a second indicator indicative of the expiration of the second timeout period, the stop command, or the second warning.

11. A method, comprising:
generating, in response to an instruction from a user device, an output of a vaporizer device, the output;
transmitting, to the user device and in response to a series of signal information requests from the user device, a series of received signal strength indicators and/or power transmit values;
terminating the output, wherein the terminating of the output is responsive to one of an expiration of a timeout period, a receipt from the user device of a second instruction including a stop command, or a determination of a warning condition of the vaporizer device; and
transmitting, to the user device and in response to the terminating of the output, status information, wherein the status information comprises an indicator indicative of the timeout period expiration, the stop command, or the warning condition.

12. The method of claim 11, wherein the output comprises at least one of a haptic feedback and an animation of one or more light emitting diodes.

13. The method of claim 11, wherein the instruction defines the timeout period.

14. The method of claim 11, wherein each of the series of received signal strength indicators and/or power transmit values is responsive to a respective one of the series of signal information requests.

15. The method of claim 11, wherein the warning condition comprises one or more of a low battery level and a temperature warning.

16. The method of claim 1, further comprising:
entering, in response to a lock command from the user device, a locked state during which heater circuitry of the vaporizer device does not respond to a user activation of the vaporizer device.

17. The method of claim 1, further comprising:
responsive to a connection request from the user device, determining to connect with the user device, the determination based on a previous establishment with the user device.

18. The method of claim 1, further comprising:
generating, in response to a second instruction from the user device, a second output.

19. The method of claim 18, further comprising:
terminating the second output, wherein the terminating of the second output is responsive to one of the expiration of a second timeout period, receipt from the user device of a third instruction including a second stop command, or a determination of a second warning condition of the vaporizer device.

20. A non-transitory computer readable medium storing instructions, which when executed by at least one data processor, result in operations comprising:
generating, based on an instruction from a user device, an output of a vaporizer device;
transmitting, to the user device and in response to a series of signal information requests from the user device, a series of received signal strength indicators and/or power transmit values;
terminating the output, wherein the terminating of the output is responsive to one of an expiration of a timeout period, a receipt from the user device of a second instruction including a stop command, or a determination of a warning condition of the vaporizer device; and
transmitting, to the user device and in response to the terminating of the output, status information, wherein the status information comprises an indicator indicative of the timeout period expiration, the stop command, or the warning condition.
